SEQUENCE LISTING (1 sequence)

SEQ ID NO: 1 - DNA, 20 bp, Artificial Sequence
  Cy3-DNA Solution
cgcgatgtgggaaagattct

(19) United States
(12) Patent Application Publication
(10) Pub. No.: US 2014/0311910 A1
(43) Pub. Date: Oct. 23, 2014

(54) MICROCHIP AND METHOD OF MANUFACTURING MICROCHIP

(71) Applicant: Sony Corporation, Tokyo (JP)

(72) Inventors: Naohisa Sakamoto, Tokyo (JP); Masahiro Matsumoto, Kanagawa (JP); Hidetoshi Watanabe, Chiba (JP); Michihiro Ohnishi, Kanagawa (JP); Yoshiaki Kato, Gunma (JP); Toshio Watanabe, Kanagawa (JP)

(73) Assignee: Sony Corporation, Tokyo (JP)

(21) Appl. No.: 14/223,497

(22) Filed: Mar. 24, 2014

(30) Foreign Application Priority Data
Mar. 29, 2013 (JP) 2013-074628

(51) Int. Cl. G01N 27/447

(52) U.S. Cl. CPC G01N 27/44791
USPC 204/601; 264/293

(57) ABSTRACT

Provided is a microchip including: an inlet part to which a liquid is injected; a plurality of analysis areas to which the liquid is supplied from the inlet part; and a flow channel which is formed to supply the liquid to the plurality of analysis areas at the same time.

### CROSS REFERENCE TO RELATED APPLICATIONS

This application claims the benefit of Japanese Priority Patent Application JP 2013-074628 filed Mar. 29, 2013, the entire contents of which are incorporated herein by reference.

### BACKGROUND

The present technology relates to a microchip and a method of manufacturing the microchip. More specifically, the present technology relates to a microchip provided with a flow channel which is formed to supply a liquid to a plurality of analysis areas at the same time.

In recent years, a microchip has been developed in which fine processing technology is applied in the semiconductor industry and a well or a flow channel is installed in a substrate made of silicon or glass to perform chemical and biological analysis.

An analysis system using such a microchip is called a micro total analysis system (μ-TAS), lab-on-a-chip, a biochip or the like and has been attracting attention as a technology of enabling fast or highly efficient chemical and biological analysis, integration, and miniaturization for analysis device.

In the μ-TAS, since analysis can be made using a small amount of sample and the microchip is disposable, the μ-TAS is expected to be applied to biological analysis that uses a precious sample with minute amount or handles many samples.

An application example of the μ-TAS includes an optical detection apparatus that introduces a substance into a plurality of areas arranged on a microchip and optically detects the substance. Examples of the optical detection apparatus include an electrophoresis apparatus that separates a plurality of substances from a flow channel on a microchip by electrophoresis and optically detects the separated substance; and a reaction apparatus (for example, a realtime PCR apparatus) that progresses reaction between a plurality of substances in a well on a microchip and optically detects the generated substance.

For example, Japanese Unexamined Patent Application Publication No. 2009-284769 discloses a micro substrate provided with a sample inlet part that introduces a sample and a plurality of storage parts that store the sample; and a plurality of exhaust parts which are respectively connected to the storage parts. Specifically, the micro substrate has a flow channel structure in which a sample inlet part is communicated with each storage part through a main flow channel and a plurality of branch flow channels branched from the main flow channel.

### SUMMARY

In a microchip, in a case where there are a plurality of storing areas (analysis areas) of a sample which are connected to an inlet part of a sample solution through a flow channel, in general, the sample solution fills the analysis areas starting from the analysis area which is positioned closest to the inlet part depending on the flow channel structure. For this reason, there is a possibility that fluctuation occurs in the analysis areas at the completion time of filling with the solution. Accordingly, there is a possibility that fluctuation occurs during reaction in the analysis areas when reaction is caused in the analysis areas and an object for analysis is produced.

In the present technology, it is desirable to provide a microchip capable of suppressing the fluctuation in the plurality of analysis areas at the completion time of filling the plurality of analysis areas with a liquid.

According to an embodiment of the present technology, there is provided a microchip including an inlet part to which a liquid is injected; a plurality of analysis areas to which the liquid is supplied from the inlet part; and a flow channel which is formed to supply the liquid to the plurality of analysis areas at the same time.

Since the microchip according to the embodiment of the present technology includes a flow channel which is formed to supply the liquid to the plurality of analysis areas from the inlet part at the same time, when the liquid is injected to the inlet part, the liquid flows reach each of the analysis areas at the same time.

The flow channel may be formed in a way such that flow channel resistances from the inlet part to each of the analysis areas are substantially the same as each other, and therefore, it is possible to supply the liquid to each of the analysis areas at the same time.

The flow channel may include a main flow channel connected to the inlet part and a plurality of branch flow channels which are branched from the main flow channel and are connected to each of the analysis areas.

It is preferable that a cross-sectional area perpendicular to the flow direction of the liquid in the main flow channel be larger than a total cross-sectional area perpendicular to the flow direction of the liquid in the plurality of branch flow channels.

It is preferable that, in the plurality of analysis areas, the flow channel be formed in a way such that a flow channel resistance of a first branch flow channel which is connected to a first analysis area positioned closest to the inlet part and a flow channel resistance from a connection point of the first branch flow channel in the main flow channel to other analysis areas instead of the first analysis area are substantially the same as each other.

The microchip may include the plurality of the main flow channels which may be formed in a way such that flow channel resistances of each of the main flow channels from the inlet part to analysis areas positioned closest to the inlet part are substantially the same as each other.

The microchip may include a second flow channel through which the liquid flows out from the analysis areas; and a display area which is connected to each of the analysis areas through the second flow channel and presents supplying status of a liquid to each of the analysis areas.

The second flow channel may include a plurality of second branch flow channels connected to each of the analysis areas and a second main flow channel connected to the plurality of second branch flow channels.

The second main flow channel may be formed in a way such that the width and/or the depth of a cross-section perpendicular to the flow direction of the liquid in the second main flow channel increase gradually or in a stepwise manner toward the display area.

A storage part for preventing backflow of the liquid may be provided in a predetermined position of the second flow channel.

A reagent reservoir area may be provided separately from the analysis areas between the inlet part and the analysis areas.

In the configuration in which the flow channel is formed in a way such that flow channel resistances from the inlet part to each of the analysis areas are substantially the same as each other, the flow channel resistance may be derived from resistance elements such as the viscosity of the liquid, the length of the flow channel, and the size of a cross-section perpendicular to the flow direction of the liquid in the flow channel.

For example, in a case where the cross-section perpendicular to the flow direction of the liquid in the flow channel has a rectangular shape, the flow channel resistance in the flow channel may be calculated by the following Formula (I).

$$R = \frac{12 η L}{1 - 0.63 ( h \text{/} w )} \cdot \frac{1}{{h}^{3} w} \qquad ( I )$$

(In Formula (I) described above, R represents the flow channel resistance [Pa·s/mm³] of the flow channel, η represents the dynamic viscosity [Pa·s] of the liquid, L represents the length [mm] of the flow channel, h represents the depth [mm] of the flow channel, and w represents the width [mm] of the flow channel.)

In the configuration including a constriction part in the branch flow channel, the constriction part may be formed in a way such that flow channel resistances from the inlet part to each of the analysis areas are substantially the same as each other.

A resistant part against the flow of the liquid may be provided in the branch flow channel, in which the resistant part may be formed in a way such that flow channel resistances from the inlet part to each of the analysis areas are substantially the same as each other.

According to another embodiment of the present technology, there is provided a method of manufacturing a microchip including: forming a flow channel, through which a liquid can be supplied to a plurality of analysis areas from an inlet part to which the liquid is injected at the same time, in a substrate.

According to the embodiments of the present technology, there is provided a microchip capable of suppressing the fluctuation at the completion time of filling in the plurality of analysis areas with the liquid.

### BRIEF DESCRIPTION OF THE DRAWINGS

FIG. 1 is a top view schematically illustrating a microchip according to a first embodiment of the present technology;

FIGS. 2A and 2B are cross-sectional views schematically illustrating a microchip of a first embodiment, in which FIG. 2A is a cross-sectional view taken along line IIA-IIA of FIG. 1 and FIG. 2B is a cross-sectional schematic view taken along line IIB-IIB of FIG. 1;

FIG. 3A is an enlarged view of an area IIIA in FIG. 2B and FIGS. 3B to 3F are views corresponding to FIG. 3A for illustrating modification examples of cross-sectional shapes of flow channels;

FIG. 4 is a top view schematically illustrating a microchip according to a second embodiment of the present technology;

FIG. 5 is a top view schematically illustrating a microchip of a first modification example according to a second embodiment of the present technology;

FIG. 6 is a top view schematically illustrating a microchip of a second modification example according to a second embodiment of the present technology;

FIG. 7 is a top view schematically illustrating a microchip according to a third embodiment of the present technology;

FIG. 8 is a top view schematically illustrating a microchip according to a fourth embodiment of the present technology;

FIG. 9 is a top view schematically illustrating a microchip of a first modification example according to a fourth embodiment of the present technology;

FIG. 10 is a top view schematically illustrating a microchip of a second modification example according to a fourth embodiment of the present technology;

FIG. 11 is a view illustrating a microchip according to a fifth embodiment of the present technology and is a schematic view partially showing a top view of the microchip;

FIG. 12 is a view illustrating a microchip of a modification example according to a fifth embodiment of the present technology and is a schematic view partially showing a top view of the microchip;

FIG. 13 is a view illustrating examples of manufacturing a branch flow channel in a microchip according to modification examples of a fifth embodiment of the present technology;

FIGS. 14A to 14C are views illustrating another example of manufacturing a branch flow channel in a microchip according to modification examples of a fifth embodiment of the present technology;

FIGS. 15A and 15B are views illustrating a microchip according to a sixth embodiment of the present technology;

FIG. 16 is a view illustrating a microchip used in an example; and

FIGS. 17A and 17B are views illustrating test results according to an example and a comparative example.

### DETAILED DESCRIPTION OF EMBODIMENTS

Hereinafter, the preferred embodiments for implementing the present technology are described. Note that the embodiments described below illustrate typical embodiments of the present technology and this does not limit the scope of the present technology. In addition, configurations that are common in each embodiment described below are given of the same reference numerals and the same description will not be repeated.

Embodiments are described as follows.

### 1. First Embodiment

(A configuration example in which flow channel resistances from an inlet part to each of analysis areas are substantially the same as each other)

### 2. Second Embodiment

(A configuration example in which the length of a flow channel from an inlet part to each of analysis areas are substantially the same as each other)

### 3. Third Embodiment

(A configuration example including a plurality of main flow channels having a plurality of branch flow channels)

### 4. Fourth Embodiment

(A configuration example including a second flow channel through which a liquid flows out from an analysis area)

### 5. Fifth Embodiment

(A configuration example including a constriction part or a resistant part in a flow channel)

### 6. Sixth Embodiment

(A configuration example including a reagent reservoir area between an inlet part and analysis areas)

### First Embodiment

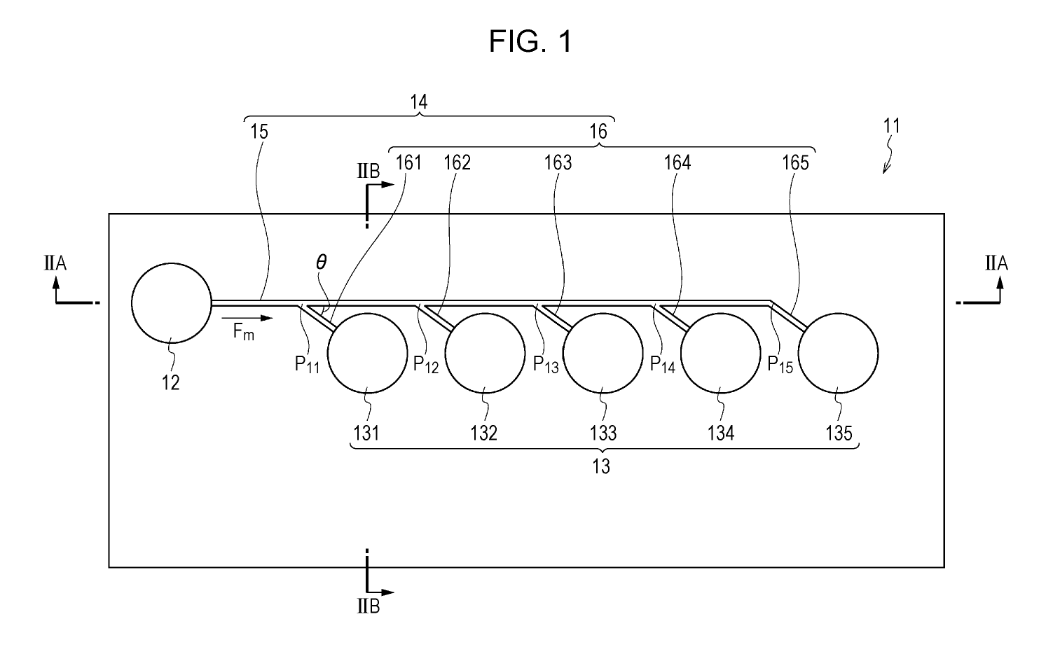

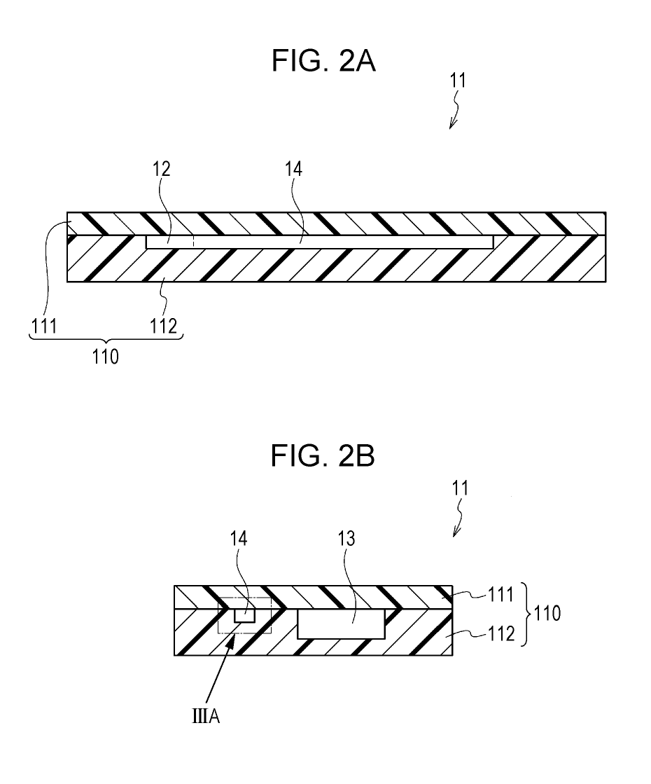

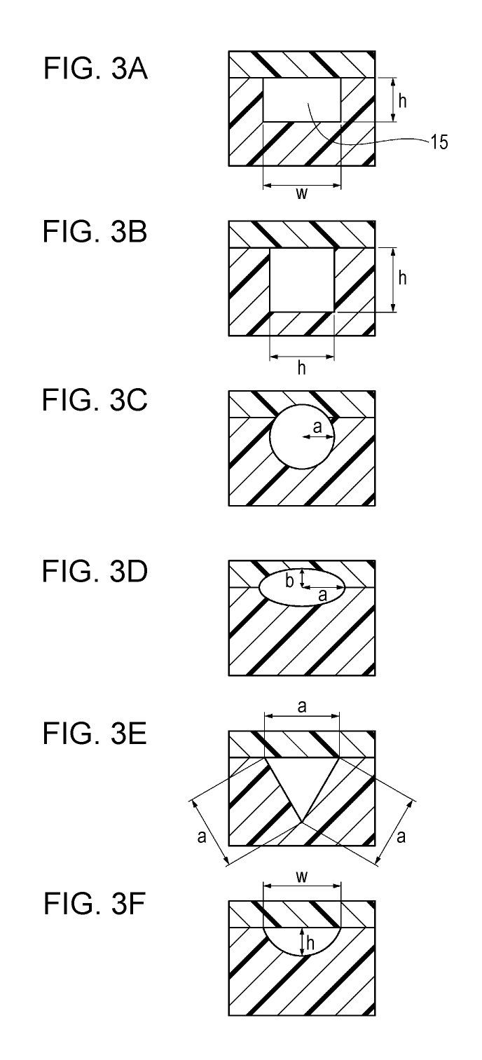

FIG. 1 is a top view schematically illustrating a microchip 11 according to a first embodiment of the present technology. FIGS. 2A and 2B are cross-sectional views schematically illustrating a microchip 11, in which FIG. 2A is a cross-sectional view taken along line IIA-IIA of FIG. 1 and FIG. 2B is a cross-sectional schematic view taken along line IIB-IIB of FIG. 1. In addition, FIG. 3A is an enlarged view of an area IIIA in FIG. 2B and FIGS. 3B to 3F are views corresponding to FIG. 3A for illustrating modification examples of cross-sectional shapes of flow channels to be described.

As illustrated in FIG. 1, the microchip 11 of the first embodiment includes an inlet part 12 to which a liquid is injected; a plurality of analysis areas 13; and a flow channel 14 which is formed to be connected to the inlet part 12 and the analysis areas 13 and to supply the liquid to the analysis areas 13 from the inlet part 12 at the same time. Moreover, the flow channel 14 is formed in a way such that the liquid is supplied to the plurality of analysis areas 13 from the inlet part 12 at the same time.

### Substrate

An inlet part 12, analysis areas 13, and a flow channel 14 are formed as a space in a substrate 110 that configures a microchip 11. The configuration of the substrate 110 that forms the microchip 11 is not particularly limited. For example, the substrate can be configured to have a plurality of substrate layers. Although FIGS. 2A and 2B show an example of two substrate layers 111 and 112, the number of substrate layer may be three or more. In addition, FIGS. 2A and 2B show an example of a configuration where the inlet part 12 or the like is formed in the substrate layer 112.

As a material of the substrate 110, glass, a resin material (polypropylene, polycarbonate, polymethyl methacrylate, or the like), and various elastomer materials (natural rubber, synthetic rubber such as polydimethylsiloxane, and thermoplastic elastomer or the like) are used. For example, it is possible to configure the microchip 11 in a way such that the inlet part 12, the analysis areas 13 and the flow channel 14 are formed as a substrate layer made of a resin and a substrate layer made of elastomer that blocks the inlet part 12 is superimposed thereon.

In a case of optically analyzing an object of analysis in the analysis areas 13, it is preferable to select a material that has optical transparency and has a small optical error with little intrinsic fluorescence and small wavelength dispersion, as the material of the substrate 110.

It is possible to mold the inlet part 12, the analysis areas 13, the flow channel 14 or the like for the substrate 110 using methods such as wet etching or dry etching of a substrate layer made of glass and nanoimprinting, injection molding, or cutting of a substrate layer made of resin. It is possible to bond the substrate 110 using a bonding agent, an adhesive, thermal fusion, anodic bonding, ultrasonic fusion, and the like. In addition, it is also possible to bond the surface of the substrate 110 by activating the surface using an oxygen plasma treatment or a vacuum ultraviolet ray treatment.

### Inlet Part

The inlet part 12 is a part to which a liquid used for analysis using a microchip 11 is injected. The inlet part may be a part of a flow channel (for example, near the end of the flow channel length in the flow channel) in terms of the inlet part being a part to which the liquid is injected.

The liquid injected to the inlet part 12 flows into the microchip 11 from the inlet part 12.

The way of injecting the liquid to the inlet part 12 is not particularly limited, but it is possible to inject the liquid using a syringe through an opening which is made in an injection part (not shown) to communicate with the outside, for example. In addition, for example, the liquid may be injected to the inlet part 12 in a way such that the inlet part 12 is blocked using a substrate layer 111 and the substrate layer 111 is punctured with a puncture member such as a needle connected to a syringe. In a case of performing the puncture injection through the substrate layer 111 that blocks the inlet part 12, a substrate layer such as polyurethane elastomer, polydimethylsiloxane or the like having a self-sealing property is suitably used as the substrate layer 111 to be punctured.

Examples of the liquid introduced to the microchip according to an embodiment of the present technology typically include a solution containing an object of analysis or a solution containing a substance that generates an object of analysis by reacting with other substance. Examples of the object of analysis include a nucleic acid such as DNA and RNA, and a protein containing peptide or antibodies. In addition, a biological reagent itself such as blood containing the object of analysis, or a diluted solution of the biological reagent may be used as the liquid introduced to the microchip according to an embodiment of the present technology.

### Analysis Areas

Analysis areas 13 are areas to which a liquid injected to an inlet part 12 is supplied through a flow channel 14 to be described. A substance contained in a liquid or a reaction product generated from reaction with a substance as the other substance is detected or analyzed as an object of analysis in the analysis areas 13. Accordingly, there is a case where an object of analysis is generated by reaction in the analysis areas 13, and therefore, the analysis areas 13 are also called reaction areas 13 in some cases.

As an analysis technique using a microchip, for example, there is an analysis technique using nucleic acid amplification reaction such as a PCR method executing a temperature cycle in the related art and various isothermal amplification methods which are not accompanied with the temperature cycle. Examples of the isothermal amplification method include various existing techniques such as an LAMP method, an SMAP method and an NASBA method. In addition, reaction accompanied with quantification of an amplification nucleic acid chain such as a real-time PCR (RT-PCR) method or an RT-RAMP method is also included in the nucleic acid amplification reaction. The microchip according to an embodiment of the present technology is suitably used in an analysis device using the nucleic acid amplification reaction and is suitable for a microchip for nucleic acid amplification reaction.

A part of a substance necessary for analysis may be stored in the analysis areas 13 in advance. For example, it is possible to store a reagent necessary for calculating an amplification product in the analysis areas 13 during the nucleic acid amplification reaction. As the reagent, for example, it is possible to use one reagent or two or more reagents selected from the group including oligonucleotide primers, enzymes, nucleic acids, monomers (dNTP), and reaction buffer solution solutes. It is possible to simply start the nucleic acid amplification reaction only by injecting a sample liquid as the liquid containing a nucleic acid to the inlet part of the microchip by the configuration in which a reagent such as an oligonucleotide primer is stored in the analysis areas.

In the first embodiment, each of the analysis areas 13 is linearly arranged side by side. In addition, the analysis areas 13 are equally arranged in a way such that the distances between the analysis areas are substantially the same as each other. Accordingly, it is possible to install more analysis areas 13 with respect to a planar area of the microchip 11 by arranging the analysis areas 13 at a regular interval.

### Flow Channel

The flow channel 14 is connected to the inlet part 12 and each of the analysis areas 13 and supplies a liquid injected to the inlet part 12 to each of the analysis areas 13.

In the first embodiment, the flow channel 14 includes a main flow channel 15 which is connected to the inlet part 12 and a plurality of branch flow channel 16 which are branched from the main flow channel 15 and are connected to each of the analysis areas 13. The main flow channel 15 has a length from the inlet part 12 to a connection point P₁₅ between the main flow channel and a fifth branch flow channel 165. Each of the branch flow channels 16 is obliquely branched from the main flow channel 15 with a predetermined angle (refer to θ of FIG. 1) with respect to the flow direction (refer to an arrow Fₘ of FIG. 1) in the main flow channel 15, and is connected to each of the analysis areas 13.

Moreover, the flow channel 14 is formed in a way such that the liquid is supplied to the plurality of analysis areas 13 from the inlet part 12 at the same time. Specifically, the flow channel is formed in a way such that flow channel resistances from the inlet part 12 to each of the analysis areas 13 are substantially the same as each other. By having such a configuration, if the liquid is injected to the inlet part 12, the liquid is supplied to the plurality of analysis areas 13 at the same time.

Here, the “same time” includes a case where, when the filling of an analysis area with the liquid is completed, other analysis areas are in a state where greater than or equal to 50% of the analysis areas are filled with the liquid or suitably in a state in which the filling of the analysis areas with the liquid is being finished, as well as a case where the liquid is simultaneously supplied to each of the analysis areas.

In addition, the “flow channel resistance” indicates as to how the liquid hardly (easily) flows through the flow channel. The flow channel resistance is based on resistance elements such as the length, the width, the depth and the shape of the flow channel, the properties of a wall surface in the flow channel, and the viscosity of the liquid flowing in the flow channel.

As described above, the flow channel 14 in the microchip 11 of the first embodiment of the present technology is formed in a way such that the flow channel resistances in the main flow channel 15 and the branch flow channel 16 from the inlet part 12 to each of the analysis areas 13 are substantially the same as each other with respect to each of the analysis areas 13. For example, it is possible to form the flow channel in a way such that the flow channel resistances are substantially the same as each other by changing the lengths of the branch flow channels 16 for every branch flow channels 16 by adjusting the widths and depths of the branch flow channels 16 or the angles θ between the branch flow channels 16 and the main flow channel 15.

Hereinafter, the flow channel structure is described in more detail.

In the first embodiment, the main flow channel 15 from the inlet part 12 to a connection point (first connection point) P₁₁ of a branch flow channel (first branch flow channel) 161 which is connected to an analysis area (first analysis area) 131 positioned closest to the inlet part 12 is common with respect to each of the analysis areas 13. Therefore, the flow channel resistance from the inlet part 12 to the first connection point P₁₁ is identical with respect to each of the analysis areas 13.

For this reason, the flow channel resistance of the first branch flow channel 161 is substantially the same as each flow channel resistance in the flow channel 14 from the first connection point P₁₁ in the main flow channel 15 to each of analysis areas 132, 133, 134, and 135 except for the first analysis area 131.

More specifically, the flow channel resistance of the first branch flow channel 161 is the same as a total flow channel resistance of the main flow channel 15 from the first connection point P₁₁ to the second connection point P₁₂ and of the second branch flow channel 162 connected to the second analysis area 132.

Similarly, the flow channel resistance of the first branch flow channel 161 is the same as a total flow channel resistance of the main flow channel 15 from the first connection point P₁₁ to a third connection point P₁₃ and of the third branch flow channel 163.

The same principle also applies to a total flow channel resistance of the main flow channel 15 from the first connection point P₁₁ to a fourth connection point P₁₄ and of a fourth branch flow channel 164, and a total flow channel resistance of the main flow channel 15 from the first connection point P₁₁ to a fifth connection point P₁₅ and of a fifth branch flow channel 165.

Accordingly, since the microchip 11 is provided with the flow channel 14 which is formed in a way such that the flow channel resistances from the inlet part 12 to each of the analysis areas 13 are substantially the same as each other, it is possible to supply the liquid injected to the inlet part 12 to the plurality of analysis areas 13 at the same time.

The above-described flow channel resistances are derived from resistance elements such as the viscosity of the liquid flowing through the flow channel 14, the length of the flow channel 14 from the inlet part 12 to each of the analysis areas 13, and the form and the size of a cross-section perpendicular to the flow direction (refer to Fₘ of FIG. 1) (hereinafter, simply referred to as “vertical section”) of the liquid in the flow channel 14.

Specifically, as shown in the schematic view of the vertical cross-section of the main flow channel 15 of FIG. 3A, the vertical cross-section of the flow channel 14 (main flow channel 15 and branch flow channel 16) has a rectangular shape and the flow channel resistance can be calculated by the following Formula (I).

$$R = \frac{12 η L}{1 - 0.63 ( h \text{/} w )} \cdot \frac{1}{{h}^{3} w} \qquad ( I )$$

Here, in Formula (I) described above, R represents the flow channel resistance [Pa·s/mm³] of the flow channel, η represents the dynamic viscosity [Pa·s] of the liquid, L represents the length [mm] of the flow channel, h represents the depth [mm] of the flow channel, and w represents the width [mm] of the flow channel.

The flow channel resistances are respectively calculated in the main flow channel 15 and the branch flow channels 16 for every flow channels 14 having different sizes. In a case of calculating the flow channel resistance of the main flow channel 15, in the above-described Formula (I), R is a flow channel resistance of the main flow channel 15, L is a length of the main flow channel 15, and h and w are respectively a depth and a width of the main flow channel 15 (refer to FIG. 3A). Furthermore, in a case of calculating the flow channel resistance of the branch flow channel 16, in the above-described Formula (I), R is a flow channel resistance of the branch flow channel 16 and L, h, and w are respectively a length, a depth, and a width of the branch flow channel 16 to be calculated.

More specifically, for example, the flow channel resistance from the inlet part 12 to the first analysis area 131 is obtained from summing up the flow channel resistance of the main flow channel 15 from the inlet part 12 to the first connection point P₁₁ and the flow channel resistance of the first branch flow channel 161.

Accordingly, the flow channel resistances from the inlet part 12 to each of the analysis areas 13 are obtained from summing up the flow channel resistances in each main flow channel 15 from the inlet part 12 to each of the connection points (P₁₁ to P₁₅) of the branch flow channels 16 connected to each of the analysis areas 13, and the flow channel resistances of each of the branch flow channels 16.

As described above, the flow channel structure in the microchip of the first embodiment is formed in a way such that the flow channel resistances from the inlet part 12 to each of the analysis areas 13 are substantially the same as each other between the analysis areas 13 (between the flow channels 14 from the inlet part 12 to each of the analysis areas 13).

Here, in an embodiment of the present technology, “substantially the same” flow channel resistances refers that each of the calculated flow channel resistance values are substantially within the same range. For example, in a case where the difference between the maximum value and the minimum value among each of the flow channel resistances from the inlet part 12 to each of the analysis areas 13 is within 5%, preferably within 2%, and more preferably within 1%, with respect to an average value of each of the flow channel resistances, the flow channel resistances are considered to be substantially the same as each other.

In addition, the microchip 11 of the first embodiment is formed in a way such that the area of the vertical cross-section of the main flow channel 15 is larger than the total area of the vertical cross-sections of the branch flow channels 16. Accordingly, it is possible to supply a liquid to the plurality of branch flow channels 16 branched from the main flow channel 15 at a sufficient flow rate.

Regarding the vertical cross-sections of the flow channel 14, it is possible adjust the flow channel resistances from the inlet part 12 to each of the analysis areas 13 and to change the width and/or the depth of the vertical cross-sections of the branch flow channels 16 for every branch flow channels.

For example, it is possible to increase the width and/or the depth of the vertical cross-sections of the plurality of branch flow channels 16, as the branch flow channel 16 is positioned in the downstream side (as the branch flow channel 16 is positioned farther from the inlet part 12). Specifically, it is possible to increase the width and/or the depth of a branch flow channel 16 positioned in the downstream side (for example, the fifth branch flow channel 165) in the vertical cross-section more than the width and/or the depth of a branch flow channel 16 positioned in the upstream side (for example, the first branch flow channel 161) in the vertical cross-section.

Accordingly, it is possible to adjust each of the flow channel resistances from the inlet part 12 to each of the analysis areas 13 by making the liquid easily flow (difficult to receive resistance) in branch flow channels 16 as the branch flow channel is positioned farther from the inlet part 12. In this case, it is suitable that the flow channel resistance of the branch flow channel 16 becomes smaller as the branch flow channel is positioned further on the downstream side than the upstream side.

The shape of the vertical cross-section of the flow channel 14 may be a square shape, a circular shape, an elliptical shape, a triangular shape, and parabolic shape (a shape having a parabola) in addition to the rectangular shape (refer to FIGS. 3A to 3F). Even if the shape of the vertical cross-section of the flow channel 14 is a shape other than the rectangular shape, it is possible to calculate the flow channel resistance according to the shape of the flow channel using the resistance elements described above.

In a case where the shape of the vertical cross-section of the flow channel is in a square shape, the flow channel resistance can be calculated using the following Formula (II) (refer to FIG. 3B).

$$R = 28.4 η L \frac{1}{{h}^{4}} \qquad ( II )$$

In Formula (II) described above, R represents the flow channel resistance [Pa·s/mm³] of the flow channel in a case where the vertical cross-section is the square shape, η represents the dynamic viscosity [Pa·s] of the liquid, L represents the length [mm] of the flow channel, and h represents the depth or the width [mm] of the flow channel in the vertical cross-section.

In a case where the shape of the vertical cross-section of the flow channel is in a circular shape, the flow channel resistance can be calculated using the following Formula (III) (refer to FIG. 3C).

$$R = \frac{8}{π} η L \frac{1}{{a}^{4}} \qquad ( III )$$

In Formula (III) described above, R represents the flow channel resistance [Pa·s/mm³] of the flow channel in a case where the vertical cross-section is the circular shape, η represents the dynamic viscosity [Pa·s] of the liquid, L represents the length [mm] of the flow channel, and a represents the radius [mm] of the flow channel in the vertical cross-section.

In a case where the shape of the vertical cross-section of the flow channel is an elliptical shape, the flow channel resistance can be calculated using the following Formula (IV) (refer to FIG. 3D).

$$R = \frac{4}{π} η L \frac{1 + {( b \text{/} a )}^{2}}{{( b \text{/} a )}^{3}} \cdot \frac{1}{{a}^{4}} \qquad ( IV )$$

In Formula (IV) described above, R represents the flow channel resistance [Pa·s/mm³] of the flow channel in a case where the vertical cross-section is in an elliptical shape, η represents the dynamic viscosity [Pa·s] of the liquid, and L represents the length [mm] of the flow channel. In addition, a and b respectively represent a semi-major axis (major axis radius) [mm] and a semi-minor axis (minor axis radius) [mm] of the flow channel in the vertical cross-section.

In a case where the shape of the vertical cross-section of the flow channel is in an equilateral triangular shape, the flow channel resistance can be calculated using the following Formula (V) (refer to FIG. 3E).

$$R = \frac{320}{\sqrt{3}} η L \frac{1}{{a}^{4}} \qquad ( V )$$

In Formula (V) described above, R represents the flow channel resistance [Pa·s/mm³] of the flow channel in a case where the vertical cross-section is the equilateral triangular shape, η represents the dynamic viscosity [Pa·s] of the liquid, L represents the length [mm] of the flow channel, and a represents the length [mm] of a side in the vertical cross-section of the flow channel.

In a case where the shape of the vertical cross-section of the flow channel is in a parabolic shape, the flow channel resistance can be calculated using the following Formula (VI) (refer to FIG. 3F).

$$R = \frac{105}{4} η L \frac{1}{{h}^{3} w} \qquad ( VI )$$

In Formula (VI) described above, R represents the flow channel resistance [Pa·s/mm³] of the flow channel in a case where the vertical cross-section is the parabolic shape, η represents the dynamic viscosity [Pa·s] of the liquid, and L represents the length [mm] of the flow channel. In addition, h represents the length [mm] of a parabola in the vertical cross-section and w represents the length [mm] of the linear portion in the vertical cross-section.

In the microchip 11 of the first embodiment described above, it is possible to supply the liquid injected to the inlet part 12 to the plurality of analysis areas 13 at the same time by forming the microchip in a way such that the flow channel resistances from the inlet part 12 to each of the analysis areas 13 are substantially the same as each other. Accordingly, it is possible to suppress the fluctuation in completion time of filling with the liquid between the analysis areas 13.

Accordingly, in a case where the object of analysis in the analysis area 13 is a substance which is generated accompanied with chemical reaction by the supply of the liquid, it is possible to adjust the reaction start condition in each of the analysis areas 13 and to reduce the fluctuation of the reaction. For example, in a case where a reagent is stored in the analysis areas 13 in advance and the reagent is dissolved in a liquid supplied to the analysis areas 13 to generate reaction, it is possible to adjust the dissolution time and to reduce the fluctuation of the reaction.

Meanwhile, in the microchip of the related art that does not have the flow channel structure in which a liquid is supplied to each analysis area at the same time, there is a fluctuation in the completion time of filling the analysis areas with the liquid causing contamination between the analysis areas or fluctuation in the amount of the liquid, in some cases. In addition, in a case where reagents are stored in the analysis areas in advance and the reagents are dissolved in a liquid to generate reaction, there is a possibility that the reagents cause nonspecific reaction (primer dimer or the like) in the analysis areas in which the reagents are dissolved in advance.

It is possible to solve such problems using the flow channel structure in which the microchip according to an embodiment of the present technology is formed in a way such that the flow channel resistances from the inlet part to each of the analysis areas are substantially the same as each other.

In addition, it is possible to supply a liquid to the plurality of branch flow channels 16 at a sufficient flow rate by forming the microchip 11 of the first embodiment in a way such that the area of the vertical cross-section of the main flow channel 15 is larger than the total area of the vertical cross-sections of the plurality of branch flow channels 16. Accordingly, it is possible to obtain the microchip 11 in which the simultaneous supply of the liquid to the plurality of analysis areas 13 can be more easily realized.

Furthermore, each length of the flow channel from the inlet part 12 to each of the analysis areas 13 is different in the microchip 11. However, by providing the flow channel structure in which the flow channel resistances are substantially the same as each other, it is possible to store the flow channel group with space saved compared to a structure in which the distances from an inlet part to each of analysis areas are the same as each other. For this reason, in the microchip 11 of the first embodiment, it is possible to arrange high density analysis areas in multiple numbers.

### Second Embodiment

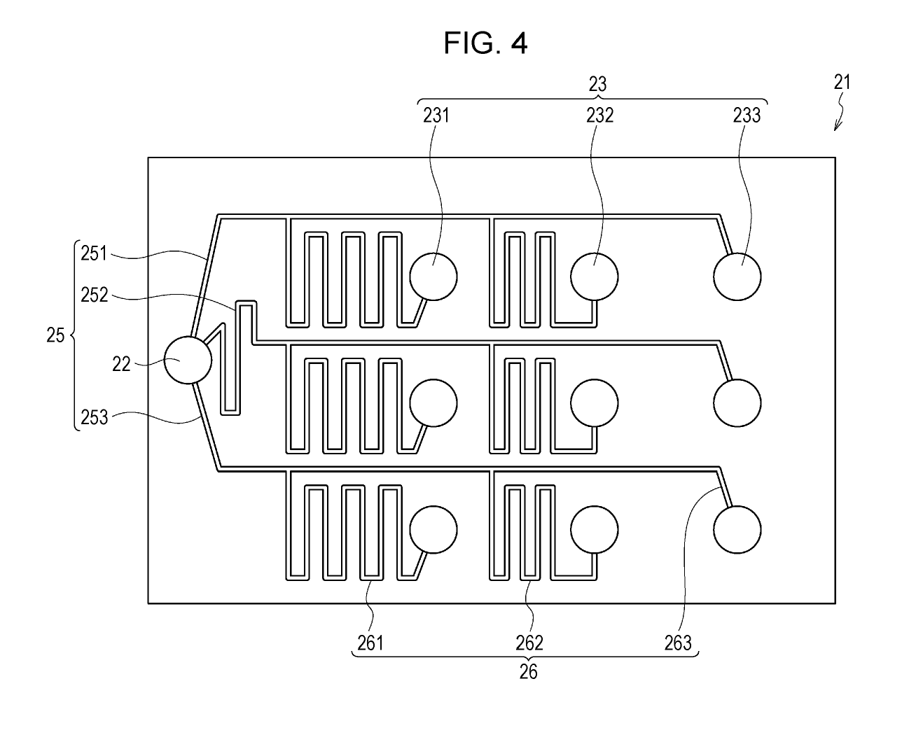

FIG. 4 is a top view schematically illustrating a microchip 21 according to a second embodiment of the present technology.

Similarly to the first embodiment, the microchip 21 of the second embodiment includes an inlet part 22; a plurality of analysis areas 23; and a flow channel 24 which is connected to the inlet part 22 and the analysis areas 23.

Since the description of the inlet part 22 and the analysis areas 23 is the same as the description provided in the first embodiment except for the arrangement position and the arrangement number, the description will not be repeated in the following embodiments and modification examples.

Similarly to the microchip 11 of the first embodiment, the microchip 21 of the second embodiment has the flow channel 24 which is formed in a way such that the liquid is supplied from the inlet part 22 to the plurality of analysis areas 23 at the same time. In addition, similarly to the flow channel 14 of the microchip 11, the flow channel 24 in the microchip 21 is formed in a way such that flow channel resistances from the inlet part 22 to each of the analysis areas 23 are substantially the same as each other.

However, the microchip 21 of the second embodiment is different from the flow channel structure in the microchip 11 of the first embodiment in that the lengths of the flow channels 24 from the inlet part 22 to each of the analysis areas 23 are formed to be substantially the same as each other with respect to the analysis areas 23.

As shown in FIG. 4, the microchip 21 has a main flow channel 25 and a plurality of branch flow channels 26 branched from the main flow channel 25, and the microchip is provided with a plurality of main flow channels 25.

Moreover, each of first branch flow channels 261 which is branched from each of the main flow channels 25 and is connected to each of first analysis areas 231 positioned in a row closest to the inlet part 22 has a bellows shape in planar view. In addition, each of second branch flow channels 262 which is branched from each of the main flow channels 25 and is connected to each of second analysis areas 232 positioned in a middle row has a bellows shape in planar view with less folding frequencies than the first branch flow channel 261. Furthermore, each of third branch flow channels 263 which is connected to each of third analysis areas 233 positioned in a row farthest to the inlet part 22, from each of the main flow channels 25 is linearly and obliquely formed from each of the main flow channels 25.

Each of main flow channels 251, 252, and 253 is formed in a way such that the lengths from the inlet part 22 to each of the first branch flow channels 261 are substantially the same as each other. Here, each of the main flow channels 25 is a flow channel having a length from the inlet part 22 to a position in which the third branch flow channel 263 is branched.

Moreover, the lengths of the first branch flow channels 261 are formed to be substantially the same as each other. In addition, the lengths of the second branch flow channels 262 and the lengths of the third branch flow channels 263 are respectively formed to be substantially the same as each other.

As described above, the microchip 21 of the second embodiment is formed in a way such that the lengths of the flow channels 24 from the inlet part 22 to each of the analysis areas 23 are substantially the same as each other by making the shapes of the main flow channels 25 and the branch flow channels 26 different from each other in planar view.

In addition, the microchip 21 is formed in a way such that the widths and the depths of the vertical cross-section of the flow channels 24 are the same as each other in addition to the lengths of the flow channels 24 from the inlet part 22 to each of the analysis areas 23. By having such a configuration, the flow channels 24 in the microchip 21 are formed in a way such that the flow channel resistances from the inlet part 22 and each of the analysis areas 23 are substantially the same as each other.

In FIG. 4, only the analysis areas 23 (231, 232, and 233) that communicate with the main flow channel 251 are given of reference numerals to show the drawing clear. However, the other analysis areas that respectively communicate with the main flow channels 252 and 253 are also given of the same reference numerals. In addition, in FIG. 4, only the branch flow channels 26 (261, 262, and 263) which are branched from the main flow channel 253 are given of reference numerals to show the drawing clear. However, the other branch flow channels which are respectively branched from the main flow channels 251 and 252 are also given of the same reference numerals.

The microchip 21 of the second embodiment described above is formed in a way such that the lengths, the widths, and the depths of the flow channels 24 from the inlet part 22 to each of the analysis areas 23 are substantially the same as each other, and thus, the flow channel resistances from the inlet part 22 to each of the analysis areas are substantially the same as each other. Accordingly, it is possible to supply the liquid injected to the inlet part 22 to the plurality of analysis areas 23 at the same time.

The microchip 21 of the second embodiment is formed in a way such that the resistance elements based on the flow channels in terms of the lengths, the widths, and the depths of the flow channels 24 connected to each of the analysis areas 23 from the inlet part 22 are the same as each other between each of the analysis areas 23. For this reason, according to the microchip 21, it is possible to suppress the fluctuation in completion time of filling each of the analysis areas 23 with the liquid without accurately controlling the resistance elements of the plurality of main flow channels 25 and branch flow channels 26. Furthermore, in a case where chemical reaction is generated in the analysis areas 23, it is possible to reduce the fluctuation of the reaction between each of the analysis areas 23.

### Modification Example of Second Embodiment

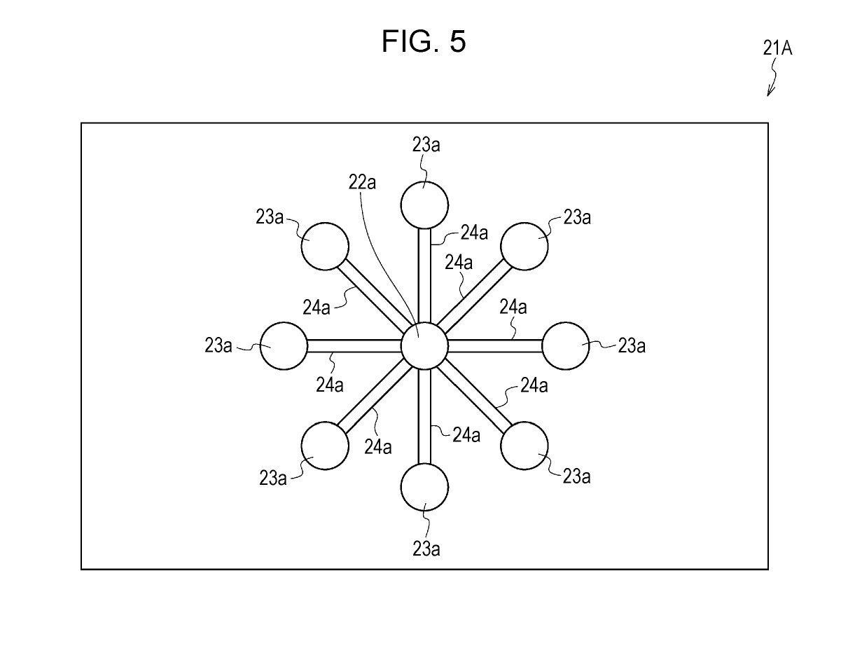

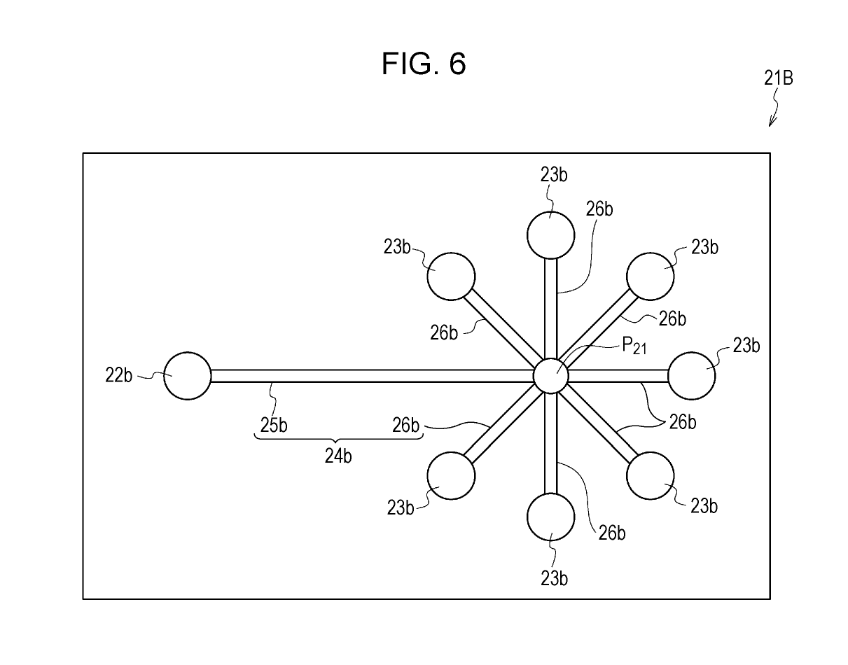

FIGS. 5 and 6 are views illustrating, as a modification example of the second embodiment, examples of configuring a microchip which is formed in a way such that the lengths of the flow channels from the inlet part to each of the analysis areas are substantially the same as each other with respect to the analysis areas.

In a microchip 21A of a first modification example shown in FIG. 5, a plurality of analysis areas 23a are provided through a plurality of flow channels 24a installed from an inlet part 22a in a radial pattern. Moreover, the microchip 21A is formed in a way such that the lengths, the widths, and the depths of the flow channels 24a are substantially the same as each other.

In addition, in a microchip 21B of a second modification example shown in FIG. 6, branch flow channels 26b are formed to be connected to each of analysis areas 23b in a radial pattern from a connection point P₂₁ which is positioned at a predetermined distance from an inlet part 22b in a main flow channel 25b connected to the inlet part 22b. Moreover, the microchip 21B is formed in a way such that the lengths of the branch flow channels from the connection point P₂₁ to each of the analysis areas 23b are the same as each other, and thus, the lengths of flow channels 24b from the inlet part 22b to each of the analysis areas 23b are the same as each other.

The microchips 21A and 21B shown in FIGS. 5 and 6 described above also exhibits the same effect as in the microchip 21 of the second embodiment.

### Third Embodiment

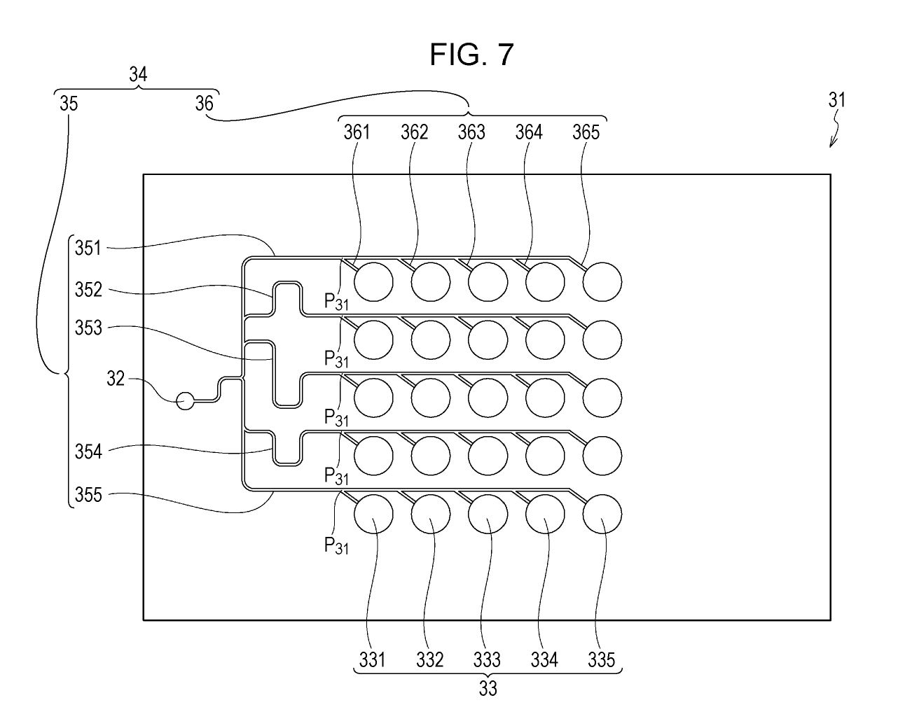

FIG. 7 is a top view schematically illustrating a microchip 31 according to a third embodiment of the present technology.

The microchip 31 of the third embodiment is configured to have the flow channel structure of the first embodiment and the flow channel structure of the second embodiment in combination.

Similarly to the microchip 11 of the first embodiment, the microchip 31 of the third embodiment has a main flow channel 35 connected to an inlet part 32 and a plurality of branch flow channels 36 connected to each of analysis areas 33 branched from the main flow channel 35. Moreover, the microchip 31 of the third embodiment includes a plurality of the main flow channels 35 provided with the plurality of branch flow channels 36. FIG. 7 illustrates an example of a flow channel structure including five main flow channels 351, 352, 353, 354, and 355 and five branch flow channels 361, 362, 363, 364, and 365 branched from each of the main flow channels 35.

The flow channel resistance of the main flow channel 35 from the inlet part 32 to a first connection point P₃₁ of a first branch flow channel 361 positioned closest to the inlet part 32 in a main flow channel 35 is formed to be substantially the same between the main flow channels 351, 352, 353, 354, and 355. Specifically, the length of the main flow channel 35 from the inlet part 32 to the first connection point P₃₁ and the width and the depth of the vertical cross-section of the main flow channel 35 is formed to be substantially the same between the main flow channels 351, 352, 353, 354, and 355.

In addition, similarly to the first embodiment, the flow channel 34 is formed in a way such that the flow channel resistance of the first branch flow channel 361 positioned closest to the inlet part 32 in a main flow channel 35 is substantially the same as each flow channel resistance from the first connection point P₃₁ to analysis areas 33 except for the first analysis area 331. The flow channel resistance of the first branch flow channel 361 and each of the flow channel resistances from the first connection point P₃₁ to the second to the fifth analysis areas 332, 333, 334, and 335 can be calculated by any of Formulas (I) to (VI) according to the shape of the vertical cross-section of the flow channel.

As described above, the microchip 31 of the third embodiment is formed in a way such that the lengths, the widths, and the depths of each of the main flow channels 35 from the inlet part 32 to the first connection points P₃₁ are substantially the same as each other. Furthermore, the flow channels 34 from the first connection points P₃₁ to the second to the fifth analysis areas 332 to 335 are formed in a way such that the flow channel resistances calculated using the resistance elements based on the shape of the flow channels 34 and the dynamic viscosity of the liquid when the liquid flows through the flow channels are substantially the same as each other. In the microchip 31 according to the third embodiment having such a configuration, it is possible to arrange high density analysis areas 33 in multiple numbers to which the liquid is supplied from the inlet part 32 at the same time compared to the microchip 21 of the second embodiment, in an identical planar area. For this reason, in the microchip 31 of the third embodiment, it is possible to increase the number of analysis results by supplying the liquid once, thereby enhancing the efficiency of the analysis. The microchip 31 of the third embodiment also exhibits the same effect as that of the microchip 11 of the first embodiment.

### Fourth Embodiment

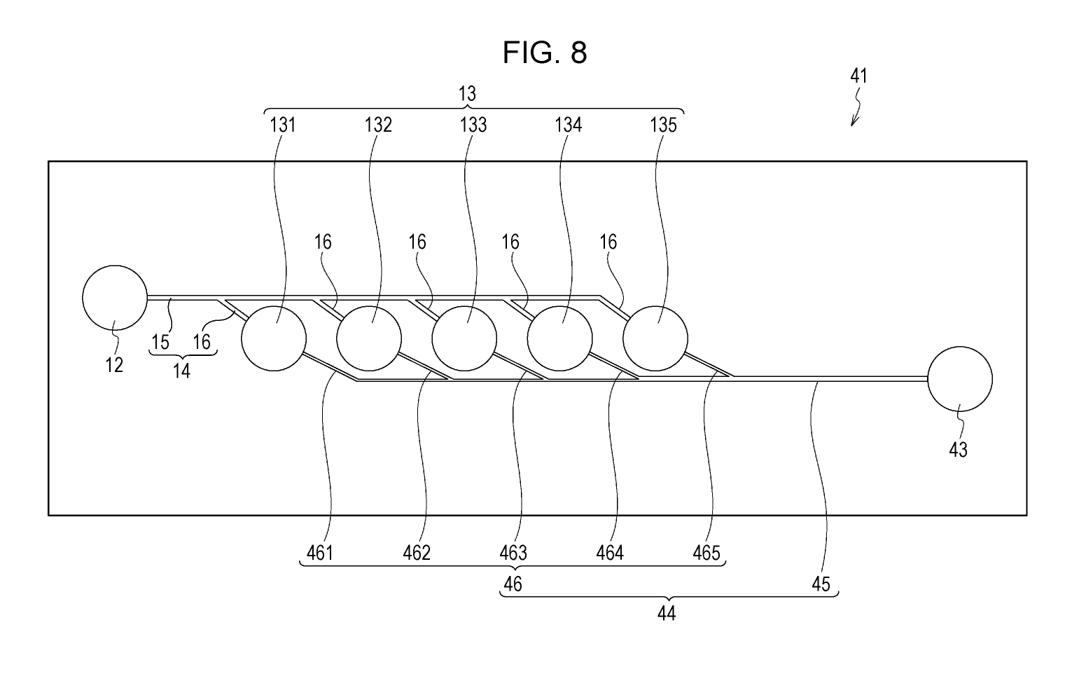

A microchip according to an embodiment of the present technology may separately have a second flow channel through which a liquid flows out from an analysis area in addition to a flow channel supplying the liquid to the analysis area from an inlet part. An example of the configuration provided with the second flow channel is shown in FIG. 8 as a top view schematically illustrating a microchip according to a fourth embodiment of the present technology.

As shown in FIG. 8, the microchip 41 of the fourth embodiment is different from that of the first embodiment in that a configuration of a display area 43 and a second flow channel 44 is added to the microchip 11 of the first embodiment. In the fourth embodiment, a configuration which is common in the first embodiment is given of the same reference numerals and the description will not be repeated.

The microchip 41 of the fourth embodiment includes a second flow channel 44 and a display area 43 connected to each of analysis areas 13 through the second flow channel 44 and is configured in a way such that a liquid passed through each of the analysis areas 13 flows into the display area 43 through the second flow channel 44.

In addition, the second flow channel 44 has a second main flow channel 45 and a plurality of second branch flow channels 46 (461, 462, 463, 464, and 465). The second flow channel 44 has the second branch flow channel 46 through which the liquid flows out from each of the analysis areas 13 for every analysis area 13. In addition, the second flow channel 44 is connected to the display area 43 through the second main flow channel 45 in a way such that the plurality of second branch flow channels 46 join the second main flow channel 45 by being connected thereto.

### Display Area

The display area 43 presents supplying status of a liquid to each of the analysis areas 13 (131, 132, 133, 134, and 135) and is formed as a space in a substrate that configures the microchip similarly to the analysis areas 13 or the like.

The display area 43 is configured in a way such that a user can visually recognize that the liquid reaches the display area 43. The arrival of the liquid at the display area 43 takes place after the completion of the filling of the analysis areas 13 with the liquid connected to the second flow channel 44. For this reason, the arrival of the liquid at the display area 43 presents the completion of the filling of the analysis areas 13 with the liquid. Conversely, no arrival of the liquid at the display area 43 presents that the filling of the analysis areas 13 with the liquid is not completed.

The presentation of the supplying status of the liquid to the analysis areas 13 using the display area 43 can be realized by a coloring material or a concave and convex structure which is installed in the display area 43 in advance. In order for a user to visually recognize the supplying status of the liquid using the display area 43 from the outer surface of the microchip 41, it is preferable to select a material having optical transparency for a substrate layer constituting the microchip 41.

The confirmation that the liquid reached the display area 43 may be implemented using a detector such as a photodetector instead of being visually checked by a user.

The above-described coloring material stored in the display area 43 in advance is a material containing a pigment that makes a user easily recognize the liquid by color development or discoloration occurred when the coloring material comes into contact with the liquid injected to the inlet part 12. Accordingly, the display area 43 presents the arrival of the liquid at the display area 43 by the change such as the color development or the discoloration of the coloring material occurred when the coloring material comes into contact with the liquid.

The above-described concave and convex structure installed in the display area 43 in advance presents the arrival of the liquid at the display area 43 using light which is reflected to the concave and convex structure.

In the microchip 41 of the fourth embodiment, the above-described display area 43 can be replaced with a discharge outlet of a liquid in a case where a liquid is pressure-injected from the inlet part or an overflow storage area to completely fill the analysis areas 13 with the liquid. It is possible for contamination to hardly occur by providing the discharge outlet and it is possible to easily fill the analysis areas 13 with the liquid by providing the overflow storage area.

In the microchip 41 of the fourth embodiment, by providing the second flow channel 44 and the display area 43 further on a downstream side than the analysis areas 13, the analysis areas 13 do not become end portions into which the liquid flows. Such a configuration has significant implications in an embodiment of the present technology having a flow channel structure in which a liquid is supplied to the plurality of analysis areas 13 at the same time. That is, it is possible to simultaneously prevent the backflow of the liquid when the liquid is supplied to the analysis areas 131 to 135 at substantially the same time. That is, it is possible to simultaneously prevent the backflow of the liquid when the liquid is supplied to each of the analysis areas 131 to 135 at substantially the same time.

From the viewpoint of preventing the backflow described above, it is preferable that the second main flow channel 45 be formed in a way such that the width and/or the depth of the vertical cross-section increase gradually or in a stepwise manner toward the display area 43. In FIG. 8, the width of the second main flow channel 45 is primarily formed at a position connected to the second branch flow channel 464 connected to the analysis area 134 and the second main flow channel 45 continues up to the display area 43 with the enlarged width. In addition, although it is not shown in the drawing, from the viewpoint of preventing the backflow, a space may be partially provided in the second flow channel 44 as a backflow preventative valve.

In the microchip 41 of the fourth embodiment, it is preferable to have a flow channel structure that satisfies the relation “the flow channel resistance of the second branch flow channel 46 (second group) the flow channel resistance of the first branch flow channel 16 (first group)”. Using the flow channel structure that satisfies the relation, it is possible to set “the amount of liquid flowing in the analysis area 13>the amount of liquid flowing out from the analysis area 13”. For this reason, even if there is deviation in the timing of supplying the liquid to the analysis areas 13 from the inlet part 12, it is possible to prevent the unevenness due to the contamination or flowing out of the liquid between the analysis areas 13. Accordingly, it is possible to provide a more high-quality microchip.

### Modification Example of Fourth Embodiment

It is possible to change the structure of the microchip 41 of the fourth embodiment that has the display area 43, the second flow channel 44, or the like as the following.

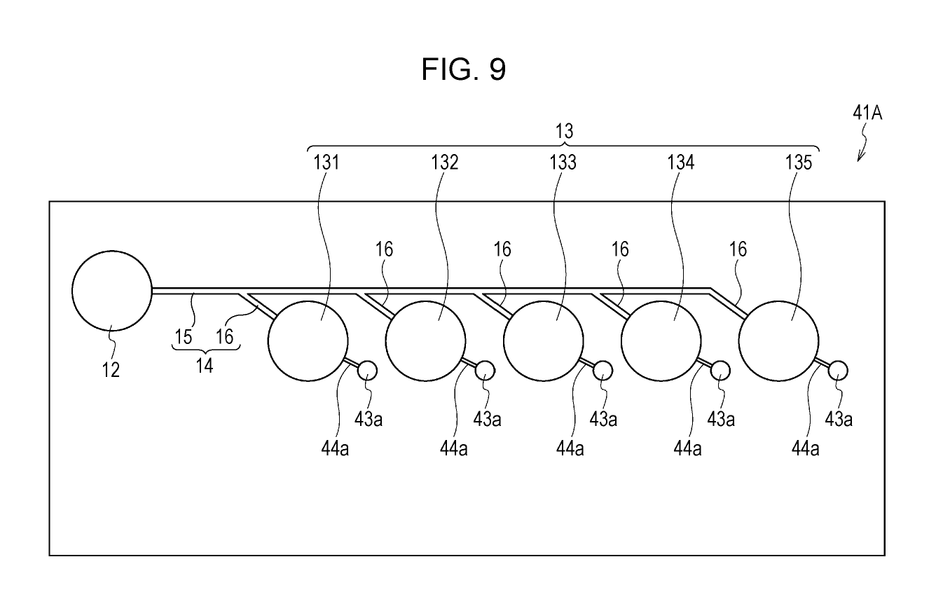

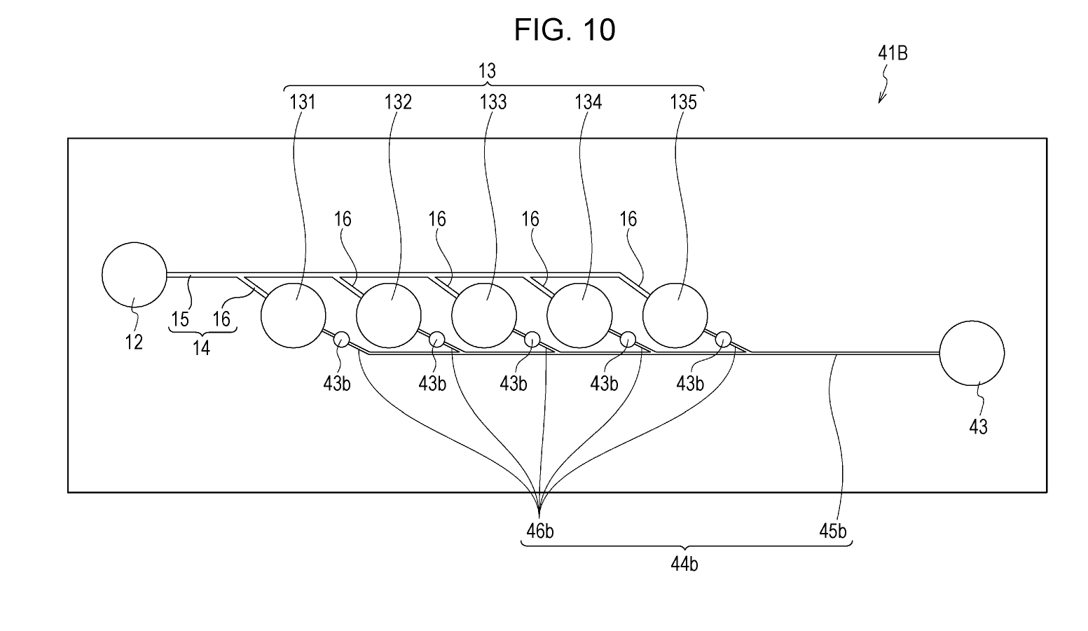

Respective FIGS. 9 and 10 are top views schematically illustrating microchips of a first modification example and a second modification example of the fourth embodiment.

A microchip 41A of the first modification example is provided with second flow channels 44a through which a liquid flows out from each of analysis areas 13 for every analysis area 13 and also is provided with display areas 43a for every second flow channel 44a. Accordingly, it is possible to promptly detect any abnormality due to the deviation of the supplying timing of the liquid to the analysis areas 13 from the inlet part 12 by installing display areas 43a for every analysis area 13.

A microchip 41B of the second modification example is provided with a second main flow channel 45b, a second flow channel 44b having a plurality of second branch flow channels 46b and a display area 43 connected to the second main flow channel 45b. Each second branch flow channel 46b is provided with a storage area for preventing backflow 43b between the analysis area 13 and the second main flow channel 45b. It is possible to prevent the backflow of the liquid using the microchip 41B of the second modification example.

### Fifth Embodiment

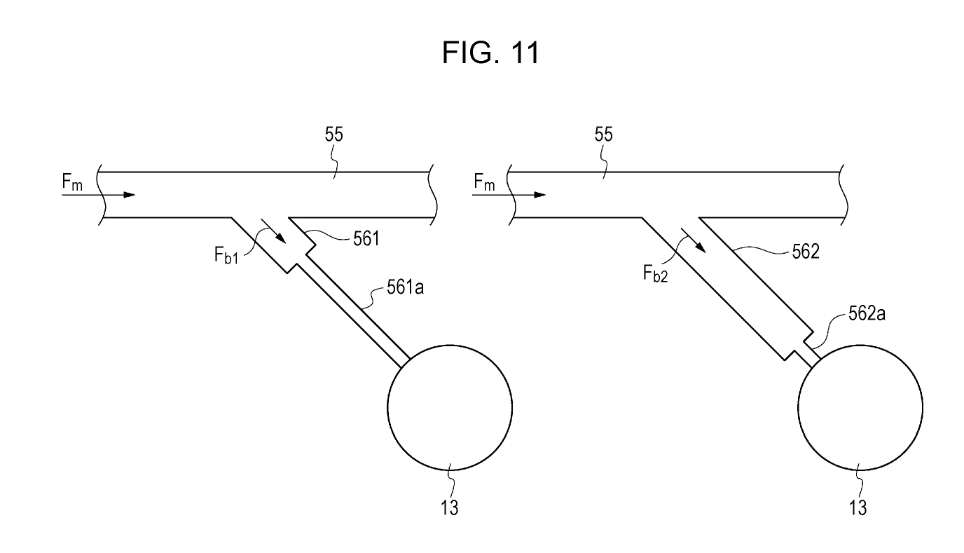

FIG. 11 is a view illustrating a microchip according to a fifth embodiment of the present technology and is a schematic view partially showing a top view of the microchip.

Similarly to the first embodiment, the microchip according to the fifth embodiment includes an inlet part to which a liquid is injected; a plurality of analysis areas 13; and a flow channel that supplies the liquid to the plurality of analysis areas 13 from the inlet part. In addition, similarly to the first embodiment, the flow channel includes a main flow channel 55 connected to the inlet part and a plurality of branch flow channels 561 and 562 which are branched from the main flow channel 55 and are connected to each of the analysis areas 13. However, the configuration of the branch flow channels 561 and 562 is different from the configuration of the branch flow channel 16 of the first embodiment.

In the fifth embodiment, the respective branch flow channels 561 and 562 have constriction parts 561a and 562a in which the channels are partially formed narrow. In addition, the fifth embodiment has a flow channel formed in a way such that the flow channel resistance from the inlet part to each of the analysis areas 13 is adjusted by the constriction parts 561a and 562b in a way such that the flow channel resistances are substantially the same as each other.

By having such a configuration, the microchip according to the fifth embodiment can supply the liquid to the plurality of analysis areas 13 from the inlet part at the same time. The constriction parts 561a and 562b are formed in a way such that the widths and/or the depths of the vertical cross-section with respect to the flow direction (Refer to arrows F_{b1} and F_{b2} of FIG. 11) of the liquid of the branch flow channels 561 and 562.

The position of the constriction parts 561a and 562a in the branch flow channels 561 and 562 is not particularly limited, but it is preferable that the constriction parts be positioned further on the analysis area 13 side instead of the main flow channel 55 side to easily control the above-described flow channel resistance. It is preferable that the constriction parts 561a and 562a be installed at a position adjacent to the analysis area 13.

The microchip according to the fifth embodiment, the lengths of the plurality of branch flow channels 561 and 562 can be set to be substantially the same as each other. Moreover, the constriction part 561a can be set longer as the analysis area 13 is positioned further on an upstream side which is close to the inlet part, and the constriction part 562a can be set shorter as the analysis area 13 is positioned further on a downstream side which is from the inlet part. By having such a configuration, it is possible to supply the liquid to each of the analysis areas 13 at substantially the same time and to uniformly install high density analysis areas 13.

As described above, in a case where the constriction parts 561a and 562a are installed in the branch flow channels 561 and 562, the volume flow rate of the liquid is controlled by making the constriction part 561a narrower and/or by making the constriction part 561a longer as the analysis area 13 is positioned where the distance of the flow channel from the inlet part to the analysis area 13 is short.

The volume flow rate is the product of the flow rate of the liquid flowing through the flow channel and the cross-sectional area of the flow channel. Since the flow rate is constant, it is possible to control the volume flow rate by changing the cross-sectional area of the flow channel. Two simple systems in which the lengths of the flow channels to the analysis area can be considered in relation to the control of the volume flow rate.

In the two systems, the cross-sectional areas of the flow channels are respectively set to S1 and S2, the lengths thereof are respectively set to L1 and L2 (here, L2=α×L1), and the flow rates of the liquid flowing through the flow channels are respectively set to V1 and V2. If it is supposed that the liquid is simultaneously filled in the analysis areas in each of the systems after a certain period of time, S1=α×S2 is derived from Q1=V1×S1×L1, Q2=V2×S2×L2, V1=V2, L2=α×L1, and Q1=Q2.

Accordingly, it is possible to adjust the supply timing of the liquid to the analysis areas by changing the cross-sectional area of the flow channel depending on the length of the flow channel.

### Modification Example of Fifth Embodiment

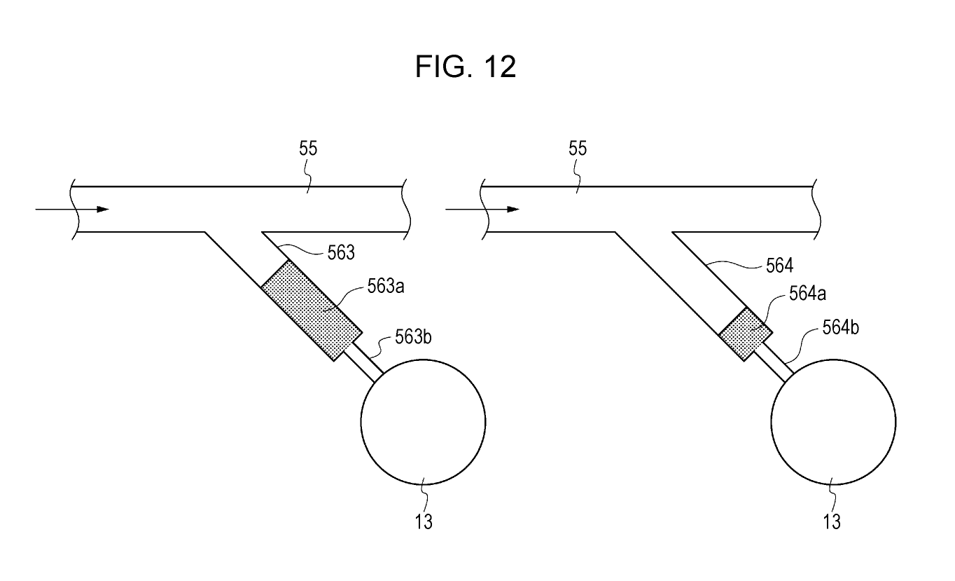

As shown in FIG. 12, resistance parts 563a and 564a that have a resistive action against the flow of a liquid may be installed in branch flow channels 563 and 564 according to a modification example of the fifth embodiment. It is possible to set the flow channel resistances from an inlet part to each of analysis areas 13 due to the resistance parts 563a and 564a. The resistance parts 563a and 564a may be provided separately from the branch flow channels 563 and 564 and be provided with the constriction parts 563b and 564b in combination as shown in FIG. 12.

As the above-described resistance parts 563a and 564a, it is possible to use pillars having a micro (μm)-order size or a nano (nm)-order size and a particle having a micro-order size or a nano-order size, which are installed in the branch flow channels 563 and 564. In addition, resistance parts in which the surfaces of the inside of the branch flow channels 563 and 564 are treated to have hydrophobicity are included as the resistance parts 563a and 564a. The volume flow rate decreases if the inside of flow channel is made to be hydrophobic, and inversely, the volume flow rate increases if the inside of the flow channel is made to be hydrophilic. Accordingly, it is possible to adjust the timing of supplying the liquid to each of the analysis areas 13 from the inlet part by hydrophilic- or hydrophobic-treating the surfaces of the inside of the branch flow channels 563 and 564.

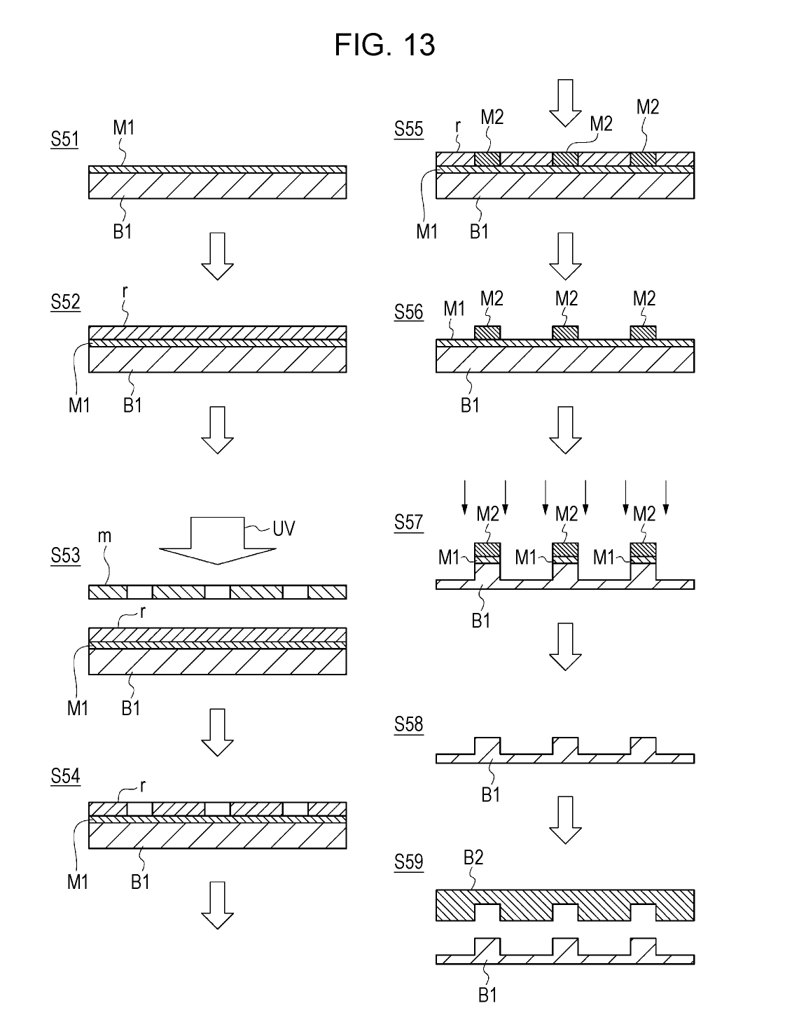

In a case where pillars are installed in the branch flow channels 563 and 564 as the resistance parts 563a and 564a, the disposition of the pillars in the branch flow channels 563 and 564 can be performed through an ultraviolet (UV) photolithography process as shown in FIG. 13, for example. The process is simply described in the following.

First, a conductive metal thin film M1 made of Ti/Au or the like is formed on a substrate B1 that forms pillars using a technique such as sputtering (step S51), and a photoresist r is coated on the metal thin film M1 (step S52). In a case where pillar patterns are directly elaborated on the substrate that configures the microchip, a photoresist using a negative resist in which solubility with respect to a developing liquid of an exposed portion is deteriorated, is preferable as the photoresist r. In this case, a convex pattern of the pillar is formed thereon. In addition, in a case of molding the substrate using a substrate on which the pillar patterns are formed as a template, a positive resist in which solubility with respect to a developing liquid of an exposed portion is improved is used. FIG. 13 shows a process example using the positive resist.

Next, a mask m in which a flow channel and a pillar pattern are installed on the photoresist r is disposed, an ultraviolet ray is radiated from the top of the mask (step S53), and then the exposed resist r portion is removed (step S54). Then, Ni plating M2 is installed on the conductive metal thin film M1 by electroplating or the like (step S55), the remaining resist r is subsequently removed (step S56), and then anisotropic dry etching is performed thereon (step S57). At this time, the Ni plating M2 portion remains because it is difficult to be etched by the anisotropic dry etching and the other portion except for the Ni plating M2 portion is etched. Thereafter, the Ni plating M2 and the conductive metal thin film M1 are removed and the substrate B1 on which fine convex patterns are formed is obtained (step S58). Finally, it is possible to mold a substrate B2 having a pillar structure using the substrate B1 as a template (step S59).

Although an example of molding the substrate B2 using a substrate on which pillar patterns are formed was illustrated in the above-described process, it is also possible to directly form the pillars on the substrate B2.

Since it is possible to control porosity using the pillar gaps, it is considered that the flow channel resistance can be easily controlled due to the formation of the pillars in the flow channel.

The surface of the pillar formed in the flow channel of the microchip can be made a hydrophobic surface by chemically modifying the surface, and in this case, it is possible to make the surface to have a reverse phase chromatograph function. In addition, it is also possible to install a micro pore having a nano-order size on the pillar. It is possible to add a function of removing unnecessary substances in the liquid by an interaction when the liquid introduced into the microchip flows through the pillars having the micro pores in the branch flow channel.

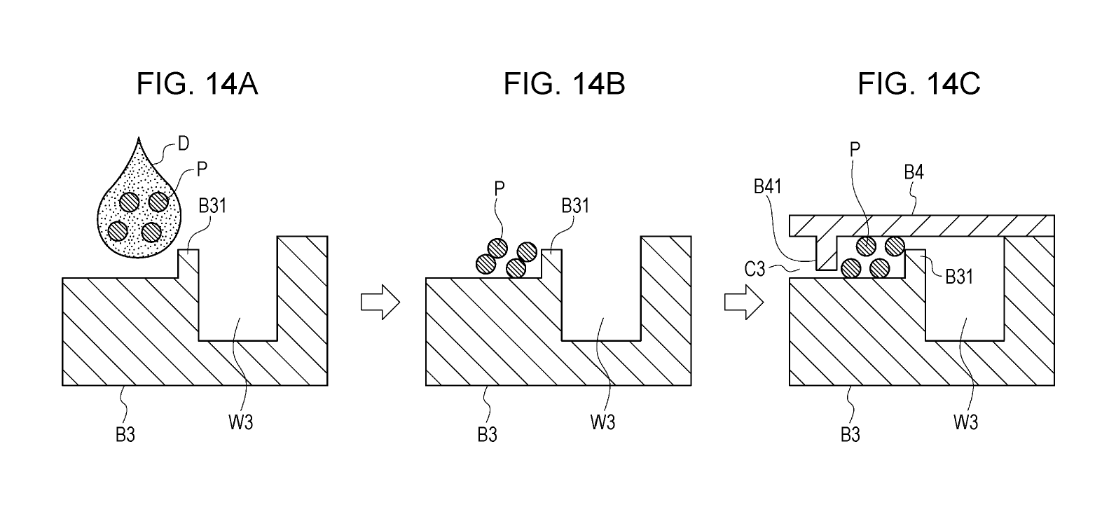

When installing particles in the branch flow channels 563 and 564 as the resistance parts 563a and 564a, the disposition of the particles in the branch flow channels 563 and 564 can be performed using a process shown in FIG. 14, for example. The process is simply described in the following.

First, in a substrate layer B3 that constitutes a microchip, a rib part B31 is formed in front (upstream side) of a recessed analysis area W3. A solution D containing a predetermined amount of particles P is dripped in front (upstream side) of the rib part B31 by using the rib part B31 as a gathering spot of the particles P (refer to FIG. 14A). At this time, if the particles P are dispersed into water or a mixture of water and alcohol, the water or the mixture of water and alcohol is evaporated after the dripping and only the particles P remain in the flow channel (refer to FIG. 14B). Thereafter, it is possible to provide a desired place with a predetermined amount of particles P by covering with a substrate layer B4 having a rib part B41 (FIG. 14C). At this time, since the particles P are caught by both the rib parts B31 and B41 in the upstream side and the downstream side of the flow channel C3, it is possible to prevent the particles P from flowing out to other places using the particles P having a particle size greater than the widths of spaces between both the rib parts B31 and B41 and respective substrate layers.

In a case of dripping the solution D into which the particles P are dispersed in a predetermined position of the flow channel C3, it is suitable to surface-treat the predetermined position to provide more hydrophilicity than the surroundings. An example of the surface treatment in this case includes plasma irradiation in an oxygen or inert gas (Ar or the like) atmosphere. In a case of hydrophilic-treating only a desired place, the desired place may be irradiated with plasma using a mask in which a pattern is formed, or the like.

In a case of installing particles as the resistance parts 563a and 564a installed in the branch flow channels 563 and 564, the amount of particles to be filled in a place where it is desired to increase the flow channel resistance is set to be large and the amount of particles to be filled in a place where it is desired to decrease the flow channel resistance is set to be less. Accordingly, it is possible to control the supply timing of the liquid to each of the analysis areas 13 from the inlet part.

In addition, it is also possible to capture the impurities or to adjust the reaction liquid when the liquid introduced to the microchip flows through the branch flow channels 563 and 564 having the particles using particles having appropriate chemical modification as the particles used in the resistance parts 563a and 564a.

### Sixth Embodiment

In the sixth embodiment of the present technology, it is possible to provide a reagent reservoir area separately from an analysis area between an inlet part and the analysis area in the microchips according to the above-described embodiments of the present technology.

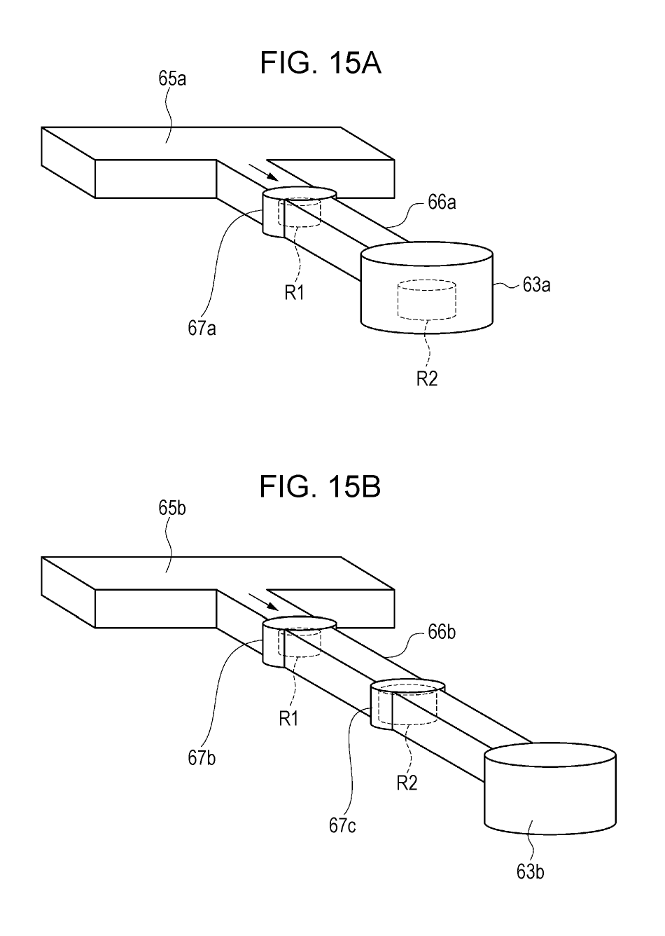

FIG. 15A is a view schematically illustrating a configuration that has a main flow channel 65a and a branch flow channel 66a and is provided with a reagent reservoir area 67a, in which a reagent is stored, in the branch flow channel 66a between the inlet part (not shown) and the analysis area 63a. In addition, FIG. 15B is a view schematically illustrating a configuration that has a main flow channel 65b and a branch flow channel 66b and is provided with two reagent reservoir areas 67b and 67c in the branch flow channel 66b between the inlet part (not shown) and the analysis area 63b.

The reagent reservoir areas 67a to 67c may be disposed further on an upstream side than the analysis areas 63a and 63b not being adjacent to the analysis areas 63a and 63b as shown in FIGS. 15A and 15B, and may be disposed in a position adjacent to the analysis areas 63a and 63b. It is preferable that the reagent reservoir areas 67a to 67c have an arc shape so as not to cause congestion of the flow of the liquid.

In the analysis area 63a, in a case where the kind of reagent necessary for reaction is greater than or equal to two, it is possible to store one kind of reagent R1 (for example, a primer or the like) in the reagent reservoir area 67a and to store another one kind of reagent R2 (for example, an enzyme or the like) in an analysis area 63a, for example (refer to FIG. 15A).

In addition, it is possible to install the reagent reservoir areas 67b and 67c in two places further on an upstream side than the analysis area 63b (refer to FIG. 15B). In this case, it is possible to store one kind of reagent R1 (for example, a primer or the like) in the reagent reservoir area 67b in an upstream side (main flow channel 65b side) and to store another one kind of reagent R2 (for example, an enzyme or the like) in the reagent reservoir area 67c in an downstream side (analysis area 63b side) (refer to FIG. 15B).

As described above, it is possible to prevent the mixing of the reagents until when a liquid is introduced in the microchip by storing reagents necessary for reaction in analysis areas 63a and 63b or in reagent reservoir areas 67a to 67c in advance. For this reason, it is possible to suppress nonspecific reaction (primer dimer, oligomer or the like) in the analysis areas. It is considered that the effect of suppressing the nonspecific reaction can be more enhanced from having the flow channel structure in which the microchip according to the sixth embodiment can supply the liquid to each of the analysis areas from the inlet part at the same time.

In addition, in the microchip according to the sixth embodiment, it is suitable to store reagents in the analysis areas 63a and 63b or in reagent reservoir areas 67a to 67c using a technique of dripping each liquid containing each reagent into the areas and of drying the dripped liquid for solidification. The solidification of the different reagents in different places does not cause any mixing of the reagents, thereby suppressing any nonspecific reaction.

In a case where each solution containing each reagent is dripped in the reagent reservoir areas 67a to 67c and is dried for the solidification, the each solution dripped into the reagent reservoir areas 67a to 67c has to be treated not to flow into flow channels (65a, 66a, 65b, and 66b). An example of the method includes controlling of surface properties. It is considered that it is possible to prevent the solution from flowing into the flow channels when dripping each solution containing each reagent into the reagent reservoir areas 67a to 67c by providing the inside of the flow channels with hydrophobicity, for example. From this point of view, it is suitable to use plastic, polydimethylsiloxane, or the like that exhibits hydrophobicity as a material of the substrate constituting the microchip.

In a case of using a material of which the surface exhibits hydrophilicity as a material of the substrate constituting the microchips 61A and 61B, it is preferable to perform a hydrophobic treatment. Examples of the hydrophobic treatment of an inorganic material such as glass include silane coupling, fluorine coating, or the like.

In addition, in a case of storing respective reagents solidified by freeze-drying or the like in the reagent reservoir areas 67a to 67c, it is desirable that the size of the solidified reagent be smaller than the diameter of the reagent reservoir areas 67a to 67c. In a case of using the freeze-drying method, the size of the solidified reagents depends on the size of the reagents when frozen. For this reason, it is desirable that the diameter of a vessel when a reagent is frozen be smaller than the diameter of the reagent reservoir areas 67a to 67c. Even in a case of compressing and solidifying a reagent, which is powdered by granulating, by tableting, it is desirable that the diameter of the solidified reagent be smaller than the diameter of the reagent reservoir areas 67a to 67c.

In a case where the reagent reservoir areas 67a to 67c are located in an upstream side of the analysis areas 63a and 63b, it is considered that the solubility is improved by the flow of the liquid generated while supplying the liquid to the reagent reservoir areas 67a to 67c. In addition, it is considered that the reagent is uniformly mixed by the dissolved reagent which is flowed into the analysis areas 63a and 63b.

In a case where the capacity of the analysis areas 63a and 63b is large, there is a case where the concentration of the reagent is not uniformly distributed because the reagent is hardly dispersed even if the reagent is dissolved in the analysis areas 63a and 63b. However, it is considered that the concentration of the reagent becomes uniform by the reagent solution, which was dissolved in the reagent reservoir areas 67a to 67c in advance, flowed into the analysis areas 63a and 63b.

In addition, in the sixth embodiment, it is possible to configure the microchip as the following.

That is, a plurality of reagent reservoir areas are installed in an upstream side of the analysis area and numbers are given to the reagent reservoir areas starting from the upstream side. Once it is determined as to which reagent is to be put in what reagent reservoir area having what number, it is possible to confirm as to which reagent is enclosed in what reagent storage location. The same principle also applied to confirmation of the reagent while manufacturing the microchip.

For example, in a case of a microchip having a configuration provided with five reagent reservoir areas in an upstream side of each of analysis areas, a reagent containing an enzyme, which is commonly used for every reaction, is enclosed in each of the analysis areas, and a reagent containing a primer for successively detecting A to E is enclosed in the first to fifth reagent reservoir areas. When manufacturing a microchip in such a manner, it is possible to automatically recognize the reagent using an image or the like, and the same principle also applies to prevention of an input error during the manufacturing.

### Combination of Embodiments

In the embodiments of the present technology, it is possible to configure a microchip according to embodiments of the present technology by appropriately combining a configuration described in each embodiment with a configuration described in other embodiments within the scope not impairing the purpose of the embodiments of the present technology. For example, parts of the branch flow channels in the microchips of the first, third, and fourth embodiments may be set as branch flow channels provided with the constriction part or the resistance part described in the fifth embodiment. In addition, for example, the second flow channel or the display area described in the fourth embodiment may be installed in parts or all of the analysis areas of the microchips of the second and the third embodiments. Furthermore, for example, a part of the main flow channel in the plurality of main flow channels in the microchip of the third embodiment may be formed in a way such that the lengths, the widths, and the depths of the flow channels from the inlet part to the plurality of analysis areas connected to the part of the main flow channel are substantially the same as each other, as described in the second embodiment.

In addition, the above-described embodiments exemplified a configuration including a inlet part, but the number of inlet parts in the microchip may be two or more. In this case, regarding a plurality of analysis areas connected to an inlet part through a flow channel, a liquid is supplied to the plurality of analysis areas connected to an inlet part, from the inlet part at the same time.

### Method of Manufacturing Microchip

The microchip according to an embodiment of the present technology as described in each of the above-described embodiments is manufactured by forming a flow channel that supplies a liquid to a plurality of analysis areas from an inlet part at the same time in a substrate. In this case, it is suitable to perform the forming of the flow channel in the substrate once the flow channel is designed in consideration of resistance elements based on the flow channel such as the length, the width, and the depth of the flow channel. As described in the description of the substrate of the first embodiment, the method of forming the flow channel in the substrate can be performed using, for example, a technique such as etching, nanoimprinting, injection molding, cutting, or the like.

An embodiment of the present technology can have configurations as the following.

(1) A microchip including: an inlet part to which a liquid is injected; a plurality of analysis areas to which the liquid is supplied from the inlet part; and a flow channel which is formed to supply the liquid to the plurality of analysis areas at the same time.

(2) The microchip according to above-described (1), in which the flow channel is formed in a way such that flow channel resistances from the inlet part to each of the analysis areas are substantially the same as each other.

(3) The microchip according to above-described (1) or (2), in which the flow channel includes a main flow channel connected to the inlet part and a plurality of branch flow channels which are branched from the main flow channel and are connected to each of the analysis areas.

(4) The microchip according to above-described (3), in which a cross-sectional area perpendicular to the flow direction of the liquid in the main flow channel is larger than a total cross-sectional area perpendicular to the flow direction of the liquid in the plurality of branch flow channels.

(5) The microchip according to above-described (3) or (4), in which, in the plurality of analysis areas, the flow channel is formed in a way such that a flow channel resistance of a first branch flow channel which is connected to a first analysis area positioned closest to the inlet part and a flow channel resistance from a connection point of the first branch flow channel in the main flow channel to analysis areas except for the first analysis area are substantially the same as each other.

(6) The microchip according to any one of above-described (3) to (5), further including: a plurality of the main flow channels, in which the main flow channels are formed in a way such that flow channel resistances of each of the main flow channels from the inlet part to analysis areas positioned closest to the inlet part are substantially the same as each other.

(7) The microchip according to any one of above-described (1) to (6), further including: a second flow channel through which the liquid flows out from the analysis areas; and a display area which is connected to each of the analysis areas through the second flow channel and presents supplying status of a liquid to each of the analysis areas.

(8) The microchip according to above-described (7), in which the second flow channel includes a plurality of second branch flow channels connected to each of the analysis areas and a second main flow channel connected to the plurality of second branch flow channels.

(9) The microchip according to above-described (7) or (8), in which the second main flow channel is formed in a way such that the width and/or the depth of a cross-section perpendicular to the flow direction of the liquid in the second main flow channel increase gradually or in a stepwise manner toward the display area.

(10) The microchip according to any one of above-described (7) to (9), in which a storage part for preventing backflow of the liquid is provided in a predetermined position of the second flow channel.

(11) The microchip according to any one of above-described (1) to (10), in which a reagent reservoir area is provided separately from the analysis areas between the inlet part and the analysis areas.

(12) The microchip according to any one of above-described (1) to (11), in which the flow channel is formed in a way such that the flow channel resistances from the inlet part to each of the analysis areas are substantially the same as each other and the flow channel resistance is derived from resistance elements such as the viscosity of the liquid, the length of the flow channel, and the size of a cross-section perpendicular to the flow direction of the liquid in the flow channel.

(13) The microchip according to above-described (12), in which the cross-section perpendicular to the flow direction of the liquid in the flow channel has a rectangular shape, and the flow channel resistance in the flow channel is calculated by the following Formula (I).

$$R = \frac{12 η L}{1 - 0.63 ( h \text{/} w )} \cdot \frac{1}{{h}^{3} w} \qquad ( I )$$

(In Formula (I) described above, R represents the flow channel resistance [Pa·s/mm³] of the flow channel, η represents the dynamic viscosity [Pa·s] of the liquid, L represents the length [mm] of the flow channel, h represents the depth [mm] of the flow channel, and w represents the width [mm] of the flow channel.)

(14) The microchip according to any one of above-described (3) to (6), further including: a constriction part in the branch flow channel, in which the constriction part is formed in a way such that flow channel resistances from the inlet part to each of the analysis areas are substantially the same as each other.

(15) The microchip according to any one of above-described (3) to (6), further including: a resistant part against flow of the liquid is provided in the branch flow channel, in which the resistant part is formed in a way such that flow channel resistances from the inlet part to each of the analysis areas are substantially the same as each other.

(16) A method of manufacturing a microchip including: forming a flow channel, through which a liquid can be supplied to a plurality of analysis areas from an inlet part to which the liquid is injected at the same time, in a substrate.

### Example

The effect of the microchip according to an embodiment of the present technology is described in detail using an example as follows.

In the example, a substrate having a three-layered structure of glass cover-pdms-glass cover in which in inlet (inlet part), a plurality of wells (analysis areas), and a flow channel pattern are formed on a substrate layer made of polydimethylsiloxane (PDMS) using a glass cover as a support is used. The formation of the inlet, the wells, and the flow channel pattern on the substrate layer is implemented by manufacturing SU-8 mold formed with the flow channel pattern or the like using photolithography and by forming PDMS using the mold (template). Accordingly, a substrate layer made of PDMS on which the flow channel pattern or the like is transferred is obtained.

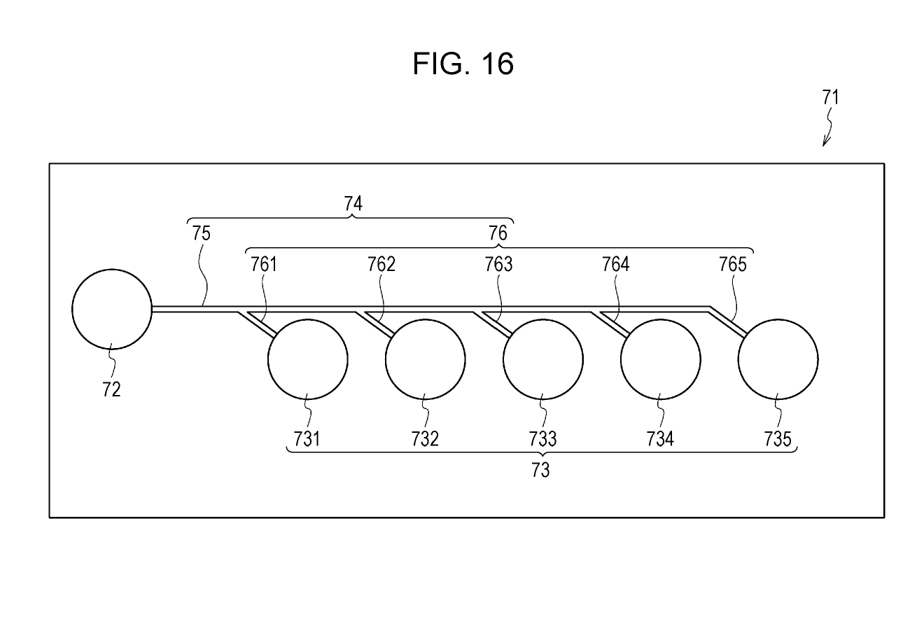

A top view schematically illustrating the thus manufactured microchip 71 is shown in FIG. 16.

The microchip 71 is provided with an inlet 72 to which a sample solution (liquid) is injected, five wells 73 (731, 732, 733, 734, and 735), and a flow channel 74 connected from the inlet 72 to the wells 73. Moreover, the flow channel 74 has a main flow channel 75 and five branch flow channels 76 (761, 762, 763, 764, and 765) connected to each of the wells 73 branched from the main flow channel 75.

When manufacturing the microchip 71, the lengths of the main flow channel 75 and the branch flow channels 76 and the size (widths and depth) of the shape of the vertical cross-section are set as Table in a way such that the flow channel resistances from the inlet 72 to each of the wells 73 are substantially the same as each other. The flow channel resistances are calculated by Formula (I) described in the first embodiment. In addition, since the main flow channel 75 from the inlet 72 to the well 731 positioned closest to the inlet 72 is common with respect to each of the analysis areas, the size of the common part of the main flow channel 75 is omitted in Table.

TABLE

| | First well 731 | Second well 732 | Third well 733 | Fourth well 734 | Fifth well 735 |
|---|---|---|---|---|---|
| Main flow | 0 | 5 | 10 | 15 | 20 |
| channel length | | | | | |
| (mm) | | | | | |
| Main flow | 0.2 | 0.2 | 0.2 | 0.2 | 0.2 |
| channel width | | | | | |
| (mm) | | | | | |
| Main flow | 0.1 | 0.1 | 0.1 | 0.1 | 0.1 |
| channel depth | | | | | |
| (mm) | | | | | |
| Main flow | 0 | 986409 | 1972818 | 2959227 | 3945636 |
| channel | | | | | |
| resistance | | | | | |
| (Pa · s/mm³) | | | | | |
| Branch flow | 2 | 2 | 2 | 2 | 2 |
| channel length | | | | | |
| (mm) | | | | | |
| Branch flow | 0.1 | 0.1 | 0.1 | 0.1 | 0.1 |
| channel width | | | | | |
| (mm) | | | | | |
| Branch flow | 0.03 | 0.031 | 0.0323 | 0.0337 | 0.0353 |
| channel depth | | | | | |
| (mm) | | | | | |
| Branch flow | 0.003 | 0.0031 | 0.00323 | 0.00337 | 0.00353 |
| channel cross- | | | | | |
| sectional area | | | | | |
| (mm²) | | | | | |
| Branch flow | 10960406 | 10011339 | 8941542 | 7960974 | 7016577 |
| channel | | | | | |
| resistance | | | | | |
| (Pa · s/mm³) | | | | | |
| Total flow | 10960406 | 10997748 | 10914360 | 10920201 | 10962213 |
| channel | | | | | |
| resistance | | | | | |
| (Pa · s/mm³) | | | | | |

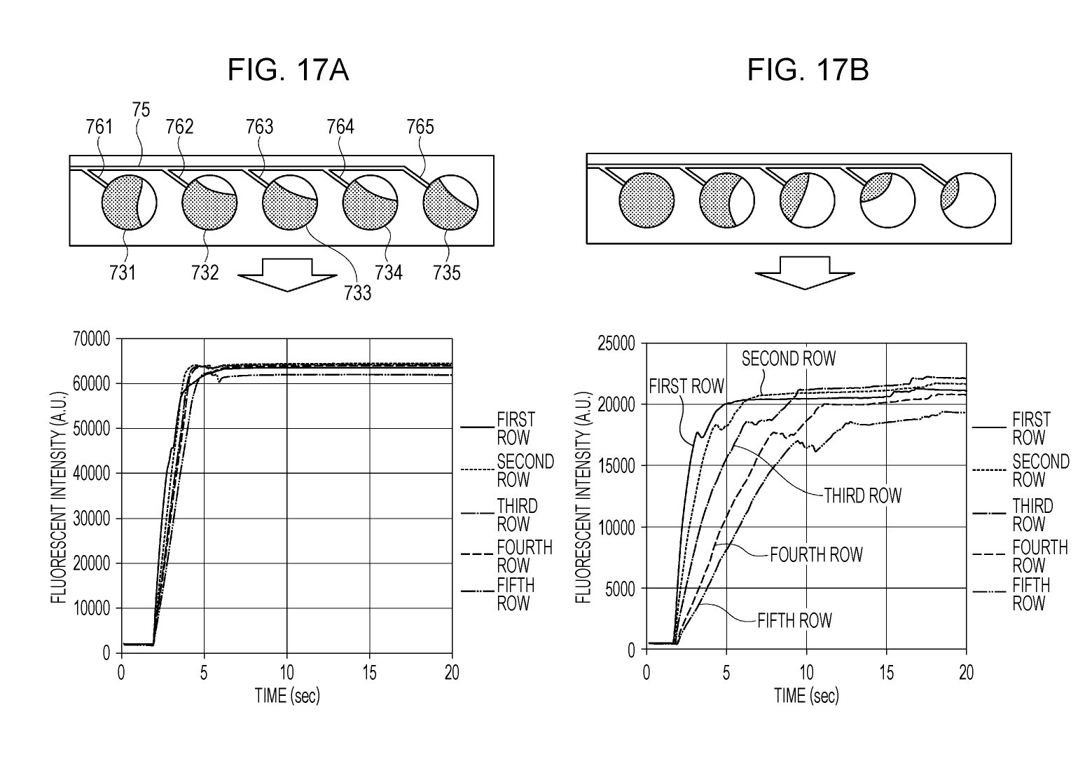

100 μM of Cy3-DNA solution (sequence: [Cy3]CGCGATGTGGGAAAGATTCT) was vacuum-injected to the inlet 72 of the microchip 71 as a sample solution. Then, the situation of the injection of the sample solution to each of the wells 73 was photographed at 8.8 shot/second and an average value of the fluorescence intensity in each well is plotted with respect to the time by analyzing the photographed connection image file using image analysis software. The result is shown in FIG. 17A together with the image suitable for indicating the timing of supplying the sample solution to each of the wells 73.

The result of a comparative example performed similarly to the above-described experiment is also shown in FIG. 17B. In the comparative example, the position, the size, and the like of the inlet and the wells are the same as those in the example, but a microchip which is not formed in a way such that the flow channel resistances from the inlet to each of the wells are substantially the same as each other was used.

As shown in FIG. 17B, it was found that the sample solution was supplied to a well starting from a well which is positioned closest to the inlet in the microchip of the comparative example. Moreover, when the filling of a well positioned closest to the inlet with the sample solution is finished, the filling amount of the wells in a third row to a fifth row was less than 50%. In addition, it was confirmed that there is a fluctuation in the fluorescence intensity in each of the wells.

On the contrary, as shown in FIG. 17A, it was confirmed that the sample solution was supplied to each of the wells 73 almost at the same time in the microchip 71 of the example. In addition, it was confirmed that the fluorescent intensities in the wells 73 also tend to be coincident. Thus, according to the microchip 71 of the example, it is possible to reduce the fluctuation of the reaction in the wells 73 due to the deviation in completion time of filling of the wells 73 with the sample solution.

It should be understood by those skilled in the art that various modifications, combinations, sub-combinations and alterations may occur depending on design requirements and other factors insofar as they are within the scope of the appended claims or the equivalents thereof.

What is claimed is:

1. A microchip comprising:
an inlet part to which a liquid is injected;
a plurality of analysis areas to which the liquid is supplied from the inlet part; and
a flow channel which is formed to supply the liquid to the plurality of analysis areas at the same time.

2. The microchip according to claim 1,
wherein the flow channel is formed in a way such that flow channel resistances from the inlet part to each of the analysis areas are substantially the same as each other.

3. The microchip according to claim 2,
wherein the flow channel includes
a main flow channel connected to the inlet part, and
a plurality of branch flow channels which are branched from the main flow channel and are connected to each of the analysis areas.

4. The microchip according to claim 3,
wherein a cross-sectional area perpendicular to the flow direction of the liquid in the main flow channel is larger than a total cross-sectional area perpendicular to the flow direction of the liquid in the plurality of branch flow channels.

5. The microchip according to claim 4,
wherein, in the plurality of analysis areas, the flow channel is formed in a way such that a flow channel resistance of a first branch flow channel which is connected to a first analysis area positioned closest to the inlet part and a flow channel resistance from a connection point of the first branch flow channel in the main flow channel to analysis areas except for the first analysis area are substantially the same as each other.

6. The microchip according to claim 5, further comprising:
a plurality of the main flow channels,
wherein the main flow channels are formed in a way such that flow channel resistances of each of the main flow channels from the inlet part to analysis areas positioned closest to the inlet part are substantially the same as each other.

7. The microchip according to claim 6, further comprising:
a second flow channel through which the liquid flows out from the analysis areas; and
a display area which is connected to each of the analysis areas through the second flow channel and presents supplying status of a liquid to each of the analysis areas.

8. The microchip according to claim 7,
wherein the second flow channel includes a plurality of second branch flow channels connected to each of the analysis areas and a second main flow channel connected to the plurality of second branch flow channels.

9. The microchip according to claim 8,
wherein the second main flow channel is formed in a way such that the width and/or the depth of a cross-section perpendicular to the flow direction of the liquid in the second main flow channel increase gradually or in a stepwise manner toward the display area.

10. The microchip according to claim 9,
wherein a storage part for preventing backflow of the liquid is provided in a predetermined position of the second flow channel.

11. The microchip according to claim 1,
wherein a reagent reservoir area is provided separately from the analysis areas between the inlet part and the analysis areas.

12. The microchip according to claim 2,
wherein the flow channel resistance is derived from resistance elements such as the viscosity of the liquid, the length of the flow channel, and the size of a cross-section perpendicular to the flow direction of the liquid in the flow channel.

13. The microchip according to claim 12,
wherein the cross-section perpendicular to the flow direction of the liquid in the flow channel has a rectangular shape, and
wherein the flow channel resistance in the flow channel is calculated by the following Formula (I).
$$R = \frac{12 η L}{1 - 0.63 ( h \text{/} w )} \cdot \frac{1}{{h}^{3} w} \qquad ( I )$$
in Formula (I) described above, R represents the flow channel resistance [Pa·s/mm³] of the flow channel, η represents the dynamic viscosity [Pa·s] of the liquid, L represents the length [mm] of the flow channel, h represents the depth [mm] of the flow channel, and w represents the width [mm] of the flow channel.

14. The microchip according to claim 3, further comprising:
a constriction part in the branch flow channel,
wherein the constriction part is formed in a way such that the flow channel resistances from the inlet part to each of the analysis areas are substantially the same as each other.

15. The microchip according to claim 3, further comprising:
a resistant part against flow of the liquid is provided in the branch flow channel,
wherein the resistant part is formed in a way such that the flow channel resistances from the inlet part to each of the analysis areas are substantially the same as each other.

16. A method of manufacturing a microchip comprising:
forming a flow channel, through which a liquid can be supplied to a plurality of analysis areas from an inlet part to which the liquid is injected at the same time, in a substrate.
